(19) United States
(12) Patent Application Publication
(10) Pub. No.: US 2026/0152137 A1
(43) Pub. Date: Jun. 4, 2026

(54) CONTROL METHOD FOR A COMPRESSED AIR SUPPLY SYSTEM, CONTROL DEVICE, AND VEHICLE

(71) Applicant: ZF CV Systems Europe BV, Brussels (BE)

(72) Inventors: Uwe Stabenow, Laatzen (DE); Jörg Meier, Hessisch Oldendorf (DE)

(21) Appl. No.: 19/457,021

(22) Filed: Jan. 22, 2026

Related U.S. Application Data
(63) Continuation of application No. PCT/EP2024/069595, filed on Jul. 11, 2024.

(30) Foreign Application Priority Data
Jul. 26, 2023 (DE) 10 2023 119 857.2

(51) Int. Cl. B60R 16/08; B01D 53/04; B01D 53/26; B60R 16/023; B60S 1/54; B60S 1/56

(52) U.S. Cl. CPC B60R 16/08; B01D 53/0446; B01D 53/0454; B01D 53/261; B60R 16/0231; B60S 1/54; B60S 1/56; B01D 2257/80; B01D 2259/40086; B01D 2259/4566

(57) ABSTRACT

A control method is for a compressed air supply system with which a control device is associated. The method includes: receiving via the control device a supply demand, activating a compressed air generator to provide compressed air at a compressed air connection when the control device receives a supply demand, identifying a regeneration execution time depending on the supply demand and/or a degree of saturation of an air dryer, activating a switching valve to open a branch line when the control device identifies a regeneration execution time, and returning compressed air from the branch line counter to a filling direction through a pneumatic main line to regenerate the air dryer. A control device is for carrying out the method. A vehicle includes such a control device.

### CROSS-REFERENCE TO RELATED APPLICATIONS

This application is a continuation application of international patent application PCT/EP 2024/069595, filed Jul. 11, 2024, designating the United States and claiming priority from German application 10 2023 119 857.2, filed Jul. 26, 2023, and the entire content of both applications is incorporated herein by reference.

### TECHNICAL FIELD

The present disclosure relates to a control method for controlling a compressed air supply system for a vehicle, to a control device for controlling a compressed air supply system, and to a vehicle with the same.

### BACKGROUND

In vehicles, compressed air supply systems are used to supply compressed air to compressed air consumers. For this purpose, compressed air is supplied to the compressed air supply system via the compressed air port by a compressed air provider such as a compressor or charger. Compressor or charger, respectively, are used as synonyms in the present description and are usually used to describe motor-driven units that compress air. Conjointly with the compressed air supply system, such a compressed air provider forms a compressed air supply system. Actuating such a compressed air supply system is preferably performed via an electronic control device or an electronic control unit (ECU). Such compressed air supply systems are also used in particular to supply compressed air to sensor cleaning devices as compressed air consumers. According to various embodiments, such compressed air supply systems are specified to provide compressed air at an operating pressure of 5 bar and a volumetric flow rate of preferably 30-100 l/min.

Sensor cleaning devices for vehicles are likewise known. Via a sensor cleaning device, surfaces on a vehicle, in particular sensor surfaces of sensors, can be cleaned via at least one cleaning fluid, for example compressed air. It can be achieved via cleaning sensor surfaces on vehicles, in particular at regular intervals, that there is less contamination on sensors and the latter function more reliably as a result. A clean sensor surface thus advantageously increases the reliability of driver assistance functions and/or partially autonomous and/or autonomous driving functions of a vehicle. The safety of the vehicle, its occupants and other road users is thus advantageously increased by a sensor cleaning device.

As compressed air consumers, sensor cleaning devices that use compressed air as a cleaning fluid are connected to a compressed air supply system. In the process, it is necessary to dry the compressed air provided by the compressed air supply system for the sensor cleaning device in order to prevent corrosion and, at temperatures below freezing point, frost-related damage and functional impairment of lines and the sensor cleaning device. A drying substrate in the air dryer is used for adsorbing humidity from the compressed air flowing through the air dryer, whereby the drying substrate can only adsorb humidity up to a maximum saturation. In order to maintain the operation of the air dryer, regeneration of the air dryer is therefore usually carried out automatically when compressed air flows back from a compressed air consumer via the compressed air supply port. Regeneration is presently understood to mean dehumidification of the drying substrate used in the air dryer for drying. In order to dehumidify the drying substrate, air that is drier in comparison to the humidity content of the drying substrate has to be directed through the air dryer. This drier air binds part of the adsorbed humidity of the drying substrate and thus reduces the saturation level of the air dryer. The operating time of the air dryer herein is limited by the saturation of the drying substrate in the air dryer. In the absence of any regeneration of the air dryer, the air dryer or the drying substrate in the air dryer must be replaced in order to achieve the maximum saturation of the drying substrate.

In the case of compressed air supply systems or compressed air supply systems for sensor cleaning devices, the challenge is that the compressed air supplied at the compressed air supply port cannot be recirculated to the compressed air supply system, but is discharged to clean the sensors. Thus, unlike known compressed air supply systems, such as shown in DE102017010772 A1, there is no remaining compressed air which is already dried by the air dryer and may be used for regeneration of the air dryer in the compressed air supply system.

The operating time and the operational readiness of the compressed air supply system or of the compressed air supply system for sensor cleaning devices therefore largely depends on the operational readiness of the air dryer. Thus, to date the operating time of such a compressed air supply system for sensor cleaning equipment can only be achieved by increasing the substrate quantity - that is, by a larger air dryer. However, due to space limitations, such a solution is perceived as disadvantageous.

A compressed air supply system, which overcomes these disadvantages, is assigned a control device, and the compressed air supply system furthermore includes a compressed air provider for providing compressed air at a compressed air port, a pneumatic main line with a water separator for separating humidity from the compressed air, an air dryer disposed in a filling direction downstream of the water separator for drying and directing compressed air to the compressed air supply port in the filling direction, and a branch line emanating from the pneumatic main line in the filling direction upstream of the air dryer and reconnecting downstream of the air dryer. The branch line of such a compressed air supply system has a branch line switch valve, which fluidically opens the branch line pneumatically in a first operating mode, wherein the pneumatic main line is configured to recirculate compressed air counter to the filling direction. In the process, the compressed air on the way to the air dryer passes at least one throttle which relaxes the compressed air before it flows through the air dryer.

The use of at least partially dehumidified compressed air for regeneration of the air dryer basically allows regeneration of the air dryer. However, in contrast to known compressed air supply systems, such as described in DE102017010772 A1 for example, such regeneration does not occur automatically when compressed air flows back from the air spring bellows. Instead, a controlled start of regeneration of the air dryer is required in such a manner that the compressed air supply system must be actuated in order to operate in the first operating mode, in which regeneration of the air dryer takes place. Especially since the compressed air flowing back counter to the filling direction cannot be used during regeneration or only conditionally for supplying a compressed air consumer via the compressed air supply port, the air dryer may only be regenerated in situations in which there is no safety risk due to an interrupted or reduced supply of compressed air at the compressed air supply port.

### SUMMARY

It is an object of the disclosure to specify a control method for controlling a compressed air supply system for a vehicle, which overcomes at least one of the disadvantages known from the prior art. In particular, it is an object of the present disclosure is to specify a control method which enables a demand-specific regeneration of the air dryer while ensuring an adequate compressed air supply at the compressed air supply port.

In a first aspect, the disclosure proposes a control method for achieving the object mentioned at the outset. A control method for a compressed air supply system of the type described above includes:
receiving a supply demand of the compressed air consumer by the control device,
actuating the compressed air provider, in particular an electric motor assigned to a compressor, by the control device for providing compressed air at the compressed air port as a function of the received supply demand of the compressed air consumer,
actuating a pneumatic branch line switch valve by the control device for fluidically opening the branch line pneumatically in a first operating mode, should the control device identify a regeneration implementation time,
identifying a regeneration implementation time by the control device as a function of the supply demand and/or of a status variable of the compressed air supply system defining the saturation level of the air dryer,
and
recirculating compressed air from the branch line counter to the filling direction through the pneumatic main line for regenerating the air dryer in the first operating mode.

It should be understood in this context that the method is not limited to carrying out the method steps in the above-described order.

Actuating a switch valve for blocking a pneumatic line can be understood to mean energizing and de-energizing, thus the absence of energization, depending on the configuration of the respective valve. Accordingly, actuating a switch valve for releasing a pneumatic line can be understood to mean energizing and de-energizing, depending on the configuration of the respective valve.

By opening the branch line switch valve as required in the first operating mode in such a manner that the branch line in the direction of the compressed air supply port is pneumatically fluidic, the compressed air from the branch line is directed counter to the filling direction, that is, in a recirculation direction, through the air dryer in the pneumatic main line. Due to this flow counter to the filling direction, the compressed air, which is partially dehumidified by the water separator, can be used to regenerate the air dryer in the recirculation direction. In particular, the compressed air is guided through a throttle, disposed downstream of the air dryer in the filling direction, and relaxed by the throttle. This relaxation reduces the relative humidity of the compressed air.

In the context of the disclosure, saturation of the air dryer is understood to mean saturation of the drying substrate in the air dryer by the humidity adsorbed by the compressed air to be dried. The adsorption capacity of the drying substrate is thereby guaranteed up to a maximum saturation, beyond which the drying substrate can not adsorb any further humidity.

The saturation level is therefore understood to be saturation of the drying substrate in relation to the maximum possible saturation of the drying substrate. The saturation level indicates the decisive measure for a condition-related regeneration implementation time of the air dryer. Thus, if the saturation level is 100% or 1, the air dryer can no longer adsorb humidity from the compressed air in the pneumatic main line. Such a saturation level can preferably also be determined by sensor via at least one dew point sensor.

In the context of the disclosure, the filling direction refers to the direction of the compressed air directed though a line from the compressed air port to the compressed air supply port. The pressurized line can be the pneumatic main line or a branch line configured to direct compressed air to the compressed air supply port. In embodiments in which the branch line, in addition to recirculating compressed air into the pneumatic main line, is also configured to provide compressed air at the compressed air supply port, the filling direction simultaneously describes the direction in which the branch line can pass through fluidically in the first operating mode, that is, the filling direction in this case corresponding to the direction of the compressed air supply port. To vent the compressed air consumer, the compressed air is recirculated in a venting direction, that is, in the direction counter to the filling direction, through the pneumatic main line and enters the environment via the vent port. To regenerate the air dryer, the compressed air is fed from the branch line into the pneumatic main line in a regeneration direction, that is, in the direction counter to the filling direction, and returned in this direction via the air dryer in the direction counter to the filling direction.

The recirculation direction in the context of the disclosure describes the direction of the compressed air directed through a line from the compressed air supply port counter to the filling direction.

The received supply demand can preferably also include negative values, should, for example, venting of the pneumatic system be necessary, and no compressed air supply and provision of compressed air by the compressed air provider is required. Furthermore, the supply demand can assume a value of 0, should no venting be required, but no compressed air supply and provision of compressed air by the compressed air provider is required despite this. The received supply demand can preferably assume positive values, should a compressed air supply and provision of compressed air by the compressed air provider be necessary.

Such a control device preferably includes one or a plurality of communicating control apparatuses. Thus, for example, a first control apparatus can be configured to control the compressed air consumer, a second control apparatus can be configured to control the compressed air supply system, and a third control apparatus can be configured to control the compressed air provider. The communication between these control units enables reliable data exchange and joint control of the compressed air supply system as well as the compressed air consumer and the compressed air provider.

The disclosure utilizes the concept that identifying a regeneration implementation time as a function of the supply demand and consequently actuating a branch line switch valve in the case of a regeneration allows that a low or possibly non-existent supply demand by the compressed air consumer readily allows the use of the compressed air dehumidified by the water separator for regeneration. In this context, regeneration does not affect the supply of the compressed air consumer by the compressed air supply system, so it is advantageous to carry out regeneration also as a precaution in order to reduce the saturation of the air dryer. Furthermore, the disclosure advantageously recognizes that identifying a regeneration implementation time by the control device as a function of the saturation level of the air dryer, or of one or a plurality of these defining status variables, and consequently actuating the branch line switch valve allows regeneration of the air dryer in the case of an almost achieved, or an achieved, saturation. In other words, this enables a demand-specific regeneration of the air dryer. The regeneration of the air dryer, carried out exclusively on demand, can reduce the operation of the air supply system, the task of which is to provide a compressed air supply for a compressed air consumer, to a necessary minimum. The control method according to the disclosure thus enables, on the one hand, a situation-related regeneration of the air dryer, which can be carried out whenever possible and, on the other hand, allows a regeneration of the air dryer based on demand and status, which is only carried out if the air dryer actually needs regeneration.

According to various embodiments, receiving the supply demand by the control device furthermore includes receiving a supply pressure and/or a supply volumetric flow of the compressed air to be provided at the compressed air supply port by the control device. Alternatively, the supply pressure and/or the supply volumetric flow can also be determined by the controller, as a function of the received supply demand. For example, the supply demand can indicate that two out of five nozzles of the sensor device are required for cleaning. Thus, the control device can determine based on this fact that the supply volumetric flow rate is ⅖ of the maximum volumetric flow rate of the compressed air supply system. By receiving or determining the supply pressure and/or the supply volumetric flow as the supply demand, the identification of the regeneration implementation time can also be made as a function thereof. The control device preferably identifies a difference between the system pressure provided at the compressed air port and the supply pressure to be provided or requested at the compressed air supply port. Depending on the pressure difference, compressed air which can be used to regenerate the air dryer remains. For example, if the supply demand indicates that there is no supply pressure to be provided at the compressed air supply port, all the compressed air provided at the compressed air port can be used to regenerate the air dryer. If, on the other hand, only part of the compressed air supplied at the compressed air port is required at the compressed air supply port, this allows the difference between the supplied compressed air and the required compressed air to be used for regeneration of the air dryer. In a corresponding manner, the supply volumetric flow to be provided at the compressed air supply port and its difference in comparison to the volumetric flow provided at the compressed air port also indicates a volumetric flow available for regeneration of the air dryer.

After receiving the supply demand, the method furthermore includes determining a permissible humidity content of the compressed air to be provided at the compressed air supply port by the control device. By determining the permissible humidity content of the compressed air to be provided at the compressed air supply port, the permissibility of rapid regeneration of the air dryer can also be identified in order to ensure adequate air drying. If drying by the air dryer is required due to the permissible humidity content, no regeneration of the air dryer is performed and accordingly no regeneration implementation time is formally identified. In fact, the air dryer may therefore require regeneration, but due to the environmental conditions that exclude regeneration, no regeneration implementation time is identified and the subsequent method steps are therefore not initiated. If, on the other hand, no drying by the air dryer is required due to the permissible humidity content of the compressed air, regeneration of the air dryer can be carried out at even lower saturation levels and a regeneration implementation time of the air dryer is identified accordingly.

According to various embodiments, the control device determines the permissible humidity content as a function of one, a plurality, or all of the following variables:
a temperature and/or air humidity of an environment, which is detected in particular by at least one temperature sensor array and/or an air humidity sensor,
an operating time of the compressed air provider, in particular the electric motor, which is monitored by the control device via a signal-carrying connection, in particular via a CAN bus connection,
a motor speed of the motor, in particular of a BLDC electric motor, which is monitored by the control device via a signal-carrying connection, in particular via a CAN bus connection.

By determining the ambient temperature, the control device can, for example, at a temperature of at least 20° C., preclude the freezing of the compressed air provided at the compressed air supply port, so that the air dryer does not have to be used. There is therefore a low risk of freezing. According to the disclosure, the risk of freezing is understood to be the risk that humidity contained in the compressed air provided at the compressed air supply port freezes.

Furthermore, in the event of a long operating time of the compressed air provider, such as of a compressor, the control device and the associated heating of the compressor due to the increased temperature of the compressed air can preclude freezing of the compressed air even at ambient temperatures below 20° C., so that the air dryer does not have to be used even in this case by virtue of the low risk of freezing. The same applies to a high speed of the electric motor, since in this case too an increased temperature of the compressed air compressed by the compressor can be expected and this poses only a low risk of freezing due to the increased temperature when supplied at the compressed air supply port.

An operating time of the compressed air provider is presently understood to mean at least one of the following times:
the cumulative total operating period since a vehicle was put into service,
a period of operation since the start of the journey,
an operating time within a current compressed air supply by the compressed air provider. The operating time is particularly preferably an operating time within a current compressed air supply provided by the compressed air provider. This takes into account what work the compressed air provider has already had to perform without an interim cooling phase. This operating time and the duration of any cooling phases are decisive for the temperature of the compressed air provider.

The control method further preferably includes feedback-controlling the supply pressure and/or the supply volumetric flow of the compressed air supplied to the compressed air supply port, in particular the pneumatic assembly, provided by the control device as a function of the supply demand. Thus, the control method extends the function of the control device in addition to merely receiving the supply pressure and/or the supply volumetric flow at the compressed air supply port by feedback-controlling the supply pressure and/or the supply volumetric flow at the compressed air supply port. The control device is connected for signals to at least one pressure sensor disposed in the pneumatic main line for providing sensor signals and to one pressure regulator assigned to the pneumatic main line and/or to the compressed air port, wherein the control device controls the pressure regulator as a function of the sensor signals. Feedback-controlling the pressure, or feedback-controlling the supply volumetric flow is therefore a function of the pressure in the pneumatic main line, which connects the compressed air port to the compressed air supply port. Thus, the control device can respond directly to pressure fluctuations in the pneumatic main line.

Additionally or alternatively, the control device is preferably connected for signals to the electric motor, in particular the BLDC electric motor, and is configured to provide compressed air at the supply pressure and/or the supply volumetric flow at the compressed air supply port, so as to feedback-control a motor speed of the electric motor. Thus, feedback-controlling the supply pressure and/or the supply volumetric flow can optionally also be carried out by way of feedback-controlling the motor speed of the electric motor driving the compressed air provider, in particular the compressor. Such motor speed feedback-control also allows indirect pressure feedback-control due to the direct influence on the output of the compressed air provider.

According to various embodiments, the control device is connected to a pneumatic assembly assigned to the compressed air supply port. According to various embodiments, the method furthermore includes controlling the pneumatic assembly by the control device as a function of sensor signals of a temperature sensor array associated with the compressed air provider and/or the supply demand and/or a saturation level of the air dryer.

According to various embodiments, the pneumatic assembly includes a controllable throttle valve, which is configured to throttle compressed air directed in the filling direction to the compressed air supply port in the second operating mode. The throttle valve preferably has a variable flow cross-section, wherein the control device actuates the throttle valve for changing the flow cross section. The throttle valve influences the compressed air flow by changing the flow cross section in the pneumatic main line. If the valve reduces the flow cross section, this will impede the flow of compressed air in the pneumatic main line, increasing the resistance to the compressed air flow as a result. This in turn increases the pressure ahead of the throttle point. The method thus restricts the pressure to the supply pressure by actuating the throttle valve, whereby a reduction of the flow cross section in the region of the throttle valve takes place and the compressed air then relaxes again.

If the throttle valve is actuated by the control device according to the method, for example in the first operating mode, in such a manner that a maximum cross section reduction occurs, compressed air is no longer directed to the supply port.

For restricting the volumetric flow, the throttle valve cooperates in particular with a pressure relief valve, such as a vent check valve disposed in the vent line, wherein the flow cross section in the throttle valve is reduced so far until the back pressure in front of the throttle valve reaches the pressure relief valve and provides a sufficient pressure for opening the valve. Preferably, the vent check valve opens at a pressure of at least 0.5 bar. By controlling the throttle valve in such a way, the input volumetric flow provided at the compressed air port can be divided into the supply volumetric flow for provision at the compressed air port and an excess portion which for regenerating the air dryer is recirculated counter to the filling direction.

According to various embodiments, the pneumatic assembly includes at least one first check valve opening in the filling direction, and a bypass line which emanates downstream of the check valve and reconnects upstream of the check valve and has a second check valve opening in the recirculation direction, thus counter to the filling direction. According to various embodiments, the pneumatic assembly furthermore includes a throttle valve disposed downstream in the recirculation direction of the second check valve in the bypass line, which is configured to throttle compressed air directed to the air dryer counter to the filling direction. The throttle valve preferably has a throttle point with a variable flow cross section. According to various embodiments, the throttle valve has a control pressure line and is configured to feedback-control the flow cross section as a function of the control pressure. The control pressure line preferably connects to the bypass line downstream of the throttle point in the recirculation direction - that is, in the direction counter to the filling direction. The first check valve is preferably disposed in the pneumatic main line, wherein the first check valve and the second check valve are disposed between the (first) air dryer and the compressed air supply port. Alternatively or additionally, the first check valve is preferably disposed in the (second) branch line, wherein the first check valve and the second check valve are disposed between a second air dryer and the compressed air supply port. In order to recirculate the compressed air in the branch line or the pneumatic main line, it is therefore necessary to pass the controllable throttle valve which is configured to reduce the pressure of the compressed air flowing to the respective air dryer. This compressed air is then preferably directed via a throttle located downstream of the air dryer in the filling direction and further relaxed by the throttle. As a result of the associated relaxation of the compressed air, the latter can absorb more humidity during regeneration of the air dryer.

Furthermore, the method preferably includes actuating or activating as required an additional compressed air source as a function of the supply demand and/or of a saturation level of the air dryer and/or of a sensor signal of a temperature sensor array assigned to the compressed air provider. This means that an additional compressed air source is activated in addition to the compressed air provider. An additional compressed air source increases the available compressed air quantity, that is, the available volumetric flow rate, enabling a response to variable system requirements. An increased supply demand in terms of the supply volumetric flow can occur, for example, in the case that all nozzles of a sensor cleaning device are to be supplied with compressed air. Owing to the fact that the control device, as a function of this supply demand, cab add an additional compressed air source, a response to such supply demands is possible and a sufficient supply volumetric flow at the supply pressure for the supply of all nozzles can be provided. Furthermore, it may be necessary to switch off the one compressed air provider in the event of imminent overheating. By activating the additional compressed air source as a function of the sensor signals of the temperature sensor array monitoring the first compressed air provider, such overheating can be detected early and the operation of the compressed air supply system can still be maintained by the compressed air source.

Furthermore, a volumetric flow at the compressed air port, that is, an input volumetric flow, above the supply volumetric flow of, for example, 30 l/min can preferably be provided by activating the compressed air source. An increased input volumetric flow, which is above the supply volumetric flow to be provided at the compressed air supply port, is particularly advantageous in the regeneration of the first or the second air dryer or in a simultaneous regeneration of the air dryer, while providing compressed air at the compressed air supply port. The increased input volumetric flow improves the efficiency of regeneration, so that the activation of the compressed air source is advantageous, especially in the case of a high saturation or a high saturation level. In this way, the saturation level can be quickly reduced. Particularly advantageously, two air dryers can be regenerated at the same time by activating the compressed air source for providing an input volumetric flow above the supply volumetric flow.

Furthermore, the compressed air source is preferably configured to provide an input pressure above the supply pressure of, for example, 5 bar at the compressed air port. The increased input pressure improves the efficiency of regeneration, so that the activation of the compressed air source to increase the input pressure is advantageous, especially in the case of a high saturation or a high saturation level.

According to various embodiments, the control device identifies a regeneration implementation time, should the supply pressure and/or the supply volumetric flow and/or the permissible humidity content of the compressed air and/or the status variable be outside a predefined value range. Thus, depending on the performance requirements of the compressed air supply system and safety requirements of a vehicle which has such a compressed air supply system, one or a plurality of corresponding value ranges can be defined, enabling a response to different requirements. The predefined value range specifies a range within which regeneration should not be carried out. This is the case, for example, when a supply demand with a high supply pressure or a high supply volumetric flow rate of in particular 5 bar or at least 30 l/min is required, or else when the air dryer is used for a short period of time. For example, the permissible intake air humidity content is >1 g/m3. Regeneration is therefore only carried out if the humidity of the intake air is, for example, ≤1g/m 3.

According to various embodiments, the status variable or the status variables include one, a plurality, or all of the following:
operating time of the compressed air provider, number of regenerations and/or period since last regeneration and/or a number of actuations and/or a duration of actuation of the branch line switch valve and/or of a main line switch valve located in the pneumatic main line. The saturation level of the air dryer correlates to these status variables and can therefore be defined by them in an appropriate manner. Due to an increased operating time of the compressed air provider, a larger amount of compressed air is simultaneously fed through the air dryer, so that a higher saturation level tends to be achieved. The same applies for a long period of time since the last regeneration of the air dryer. A high number of regenerations within a defined time period, on the other hand, tends to indicate a lower saturation of the air dryer.

It is furthermore preferable that the method includes calculating the saturation level of the air dryer by the control device, wherein the saturation level is calculated as a function of a temperature of the environment and a humidity of the environment and one, a plurality, or all of the following status variables: operating time and/or motor speed of the compressed air provider, number of regenerations and period since the last regeneration. If the saturation level is determined on the basis of all of these variables, it can be calculated with a high degree of accuracy in a saturation simulation. Especially since the saturation level correlates to each of these status variables, one of these quantities in conjunction with the temperature and the humidity is sufficient to calculate an at least approximate saturation level of the air dryer.

It is furthermore preferable that the temperature and/or the humidity include a current temperature and/or air humidity of the environment, wherein the method includes accessing the current temperature and/or humidity by the control device of at least one connected for signals temperature sensor array and/or humidity sensor or from a connected for signals on-board network. By accessing the current temperature, a regeneration implementation time can be reliably identified as a function of the current ambient conditions. In particular, fluctuations with respect to an average temperature or a predicted temperature are taken into account in this way. A temperature sensor array or humidity sensor can detect such a temperature or humidity directly in the environment of the vehicle. An on-board network can also access this temperature and/or humidity from connected for signals temperature sensors of a temperature sensor array or humidity sensors or else access the temperature in particular via wireless data connections from weather stations in the environment or from the Internet, taking into account the current vehicle position.

The control device preferably has a memory and is configured to access information regarding the temperature and/or the humidity or of status variables during the operating period of the air dryer. Further according to various embodiments, the control device is configured to access information of a dew point sensor for determining the saturation level.

Further according to various embodiments, the temperature and/or the air humidity includes a predicted temperature and/or air humidity of the environment along a route and/or at a destination. The method preferably includes accessing location information regarding the route and/or the destination and accessing environmental information assigned to the location information by the control device of a connected for signals on-board network and/or a navigation system. By accessing location and environmental information, such as temperature or air humidity, it is possible to determine predicted ambient temperatures and/or air humidity. This allows for predictive control of the compressed air supply system, in particular with regard to the identification of the regeneration implementation time. The control device can thus also consider future situations, which include an influence on the supply demand and in particular the permissible air humidity of the compressed air at the compressed air supply port. In the case of a predicted temperature below the freezing point at the destination, for example, a regeneration implementation time is identified by the control system at an early stage due to a future supply demand that can be determined from this. Thus, predictive control and a control method with increased operational reliability are provided.

According to various embodiments, the method furthermore includes actuating a vent valve by the control device for releasing a vent line emanating in the filling direction upstream of the air dryer from the pneumatic main line to a vent port, should the control device identify a regeneration implementation time. Thus, the compressed air exiting the air dryer counter to the filling direction can be directed via the vent line to the vent port and discharged via it.

According to various embodiments, the method furthermore includes actuating a main line switch valve for blocking the pneumatic main line in the filling direction, in particular upstream of the air dryer, should the control device identify a regeneration implementation time. Thus, the compressed air recirculated in the pneumatic main line counter to the filling direction for regeneration of the air dryer does not first have to displace the compressed air in the pneumatic main line, but can be directed unhindered through the pneumatic main line counter to the filling direction and preferably discharged via the vent port.

### ACCORDING TO VARIOUS EMBODIMENTS, THE METHOD INCLUDES THE

following step:
flushing the pneumatic main line and/or the branch line by compressed air provided at the compressed air port, and discharging the compressed air via the vent line, wherein the compressed air is preferably dried by the air dryer, and flushing the pneumatic main line is performed counter to the filling direction and/or flushing the branch line is performed in the filling direction, and/or
flushing the compressed air consumer by compressed air provided at the compressed air port and preferably dried by the air dryer, and discharging the compressed air via the compressed air consumer.

By flushing the pneumatic main line and/or the branch line, residues, in particular water accumulations, can be removed in the lines and in particular air with an increased humidity content from the compressed air supply system can be discharged via the vent line to the vent port. Flushing the compressed air consumer with dried compressed air ensures that humidity in the compressed air consumer is prevented from freezing during long periods of downtime, even during previous operation with only partially dehumidified or humid compressed air. If, on the other hand, flushing generally takes place with compressed air that has not been dried by an air dryer, humidity accumulations in valves can be blown out.

According to various embodiments, the method includes the following step:
actuating the main line switch valve and the branch line switch valve for pneumatically decoupling the pneumatic main line and the branch line from the compressed air port. In the process the air dryer located in the pneumatic main line is in particular also pneumatically decoupled from the compressed air provider. By pneumatically decoupling the pneumatic main line or the branch line from the compressed air port, the system is depressurized into a sleep mode in which neither compressed air is provided at the compressed air supply port nor regeneration of the air dryer takes place. In this way, the saturation of the air dryer is not further advanced and the branch line and the pneumatic main line are protected against possible later frost-related damage. It is therefore taken into account that the ambient conditions may change, for example, while a vehicle is parked. For example, night frost could otherwise cause frost damage, which is prevented in this way. According to various embodiments, the method furthermore includes actuating the vent valve for pneumatically decoupling the vent line from the environment. This also protects the vent line in sleep mode.

Furthermore, by actuating the pneumatic assembly by the controller for distributing the compressed air carried in the branch line, it is possible to carry out a regeneration of the air dryer at the same time and to provide compressed air at the compressed air supply port via the branch line.

Further according to various embodiments, the branch line is a first branch line and the compressed air supply system furthermore includes a second branch line with a second branch line switch valve and a second air dryer, and the regeneration implementation time is a first regeneration implementation time and the air dryer is a first air dryer and the saturation level is a first saturation level. According to various embodiments, the control device, as a function of a status variable representing the saturation level of the second air dryer, selectively actuates the first branch line switch valve and/or the second branch line switch valve, should the sensor cleaning device identify a regeneration implementation time. Thus, depending on the regeneration implementation time or the extent or intensity of the regeneration implementation time, the first and/or the second branch line switch valve can be controlled selectively. The regeneration of the first air dryer via the second branch line with the second air dryer enables a faster regeneration of the air dryer, since in the second branch line drier compressed air is carried due to the second air dryer, and can correspondingly be recirculated counter to the filling direction into the pneumatic main line. If only a minor regeneration implementation time is identified, regeneration can continue to take place by actuating the first switch valve in the first branch line, wherein only compressed air dehumidified by the water separator is recirculated to the pneumatic main line counter to the filling direction for regeneration of the first air dryer.

Furthermore, the method preferably further includes the following steps:
identifying a regeneration implementation time of the second air dryer by the control device as a function of the supply demand and/or of a saturation level of the second air dryer defined by at least one state variable,
selectively actuating the first branch line switch valve and/or the main-line switch valve by the control device for fluidically opening the first branch line and/or the pneumatic main line pneumatically, should the control device identify a regeneration implementation time of the second air dryer,
recirculating compressed air from the first branch line and/or the pneumatic main line counter to the filling direction through the second branch line for regenerating the second air dryer. Thus, a regeneration implementation time of the second air dryer can also be identified by the control method according to the disclosure, and a regeneration of the second air dryer can be carried out. The regeneration implementation time of the second air dryer is identified in particular as a function of the same status variables with respect to the second air dryer, which have been described above with respect to the first air dryer.

According to various embodiments, one, a plurality, or all of the following are configured as solenoid directional control valves that are closed when de-energized:
the at least one branch line switch valve,
the at least one nozzle valve of a sensor cleaning device connected to the compressed air supply system,
the at least one vent valve, and
a compressor vent valve,
wherein the solenoid directional control valves have a coil for generating a magnetic force and an armature which is movable by the magnetic force counter to a spring force acting in the direction of a valve seat, and are specified to be moved away from the valve seat by energizing with an opening control current counter to the spring force, and to bear on the valve seat by energizing with a heating control current that is less than the opening control current, wherein the coil is specified to heat the solenoid directional control valves when the heating control current is applied. The possibility of heating the mentioned valves reduces the overall risk of malfunctions of the pneumatic system as a result of freezing. In addition to the sensor cleaning device or other compressed air consumers, this also applies in particular to the compressed air supply system.

According to various embodiments, the method further includes energizing one, a plurality, or all of the following solenoid directional control valves selectively with an opening control current and a heating control current:
the at least one branch line switch valve,
the at least one nozzle valve of a sensor cleaning device connected to the compressed air supply system,
the at least one vent valve, and
the compressor vent valve.

The possibility of heating the mentioned valves reduces the risk of malfunctions of the pneumatic system as a result of freezing. In addition to the sensor cleaning device or other compressed air consumers, this also applies in particular to the compressed air supply system. The use of the already existing coil of the solenoid valves makes it possible to dispense with additional heating elements. It should be understood that heating of the solenoid valves is necessary, especially before opening, since they remain in the closed state for longer periods of time. Damage to the valve only occurs when a valve subjected to icing, or its armature, is moved. Energizing the solenoid valve before it is actually opened prevents freezing due to heating of the valve, which is preferably maintained permanently during operation.

A heatable nozzle valve reduces the risk of frost damage at temperatures close to freezing. The threshold value from which only compressed air dried by the air dryer may be fed to the compressed air supply port is therefore shifted to lower temperatures.

Furthermore, the compressed air supply system preferably furthermore includes a compressor vent line with a compressor vent valve. The method preferably includes actuating the compressor vent valve for venting a line volume between the compressed air provider and the compressed air provider. The starting resistance for the compressor is thus reduced.

In a second aspect, the disclosure achieves the object mentioned at the outset by a control device. According to the second aspect, the disclosure proposes a control device for controlling a compressed air supply system for a vehicle, in particular a passenger automobile. The control device is assigned to the compressed air supply system for supplying a compressed air consumer via a compressed air supply port, and the compressed air supply system includes a compressed air provider for providing compressed air at a compressed air port, a pneumatic main line with an air dryer for drying and feeding compressed air to the compressed air supply port in a filling direction, and a branch line emanating from the pneumatic main line in the filling direction upstream of the air dryer and reconnecting downstream of the air dryer. The control device is configured to receive a supply demand of the compressed air consumer and to actuate the compressed air provider, and is able to be connected for signals to the compressed air consumer and to the compressed air provider. Furthermore, the control device is configured to identify a regeneration implementation time, in particular a first saturation level of the first air dryer and/or a second saturation level of the second air dryer, as a function of the supply demand and/or a saturation level defined by at least one status variable of the air dryer, and is furthermore configured to actuate the branch line switch valve for fluidically opening the branch line pneumatically when a regeneration implementation time is identified.

The control device is thus configured in particular to carry out a control method according to the first aspect of the disclosure. Advantages and preferred embodiments which have been described with reference to the first aspect are thus likewise advantages and preferred embodiments of the control device according to the second aspect of the disclosure.

According to various embodiments, one, a plurality, or all of the following are configured as solenoid directional control valves that are closed when de-energized:
the at least one branch line switch valve,
the at least one nozzle valve of a sensor cleaning device connected to the compressed air supply system,
the at least one vent valve, and
the compressor vent valve,
wherein the solenoid directional control valves have a coil for generating a magnetic force and an armature which is movable by the magnetic force counter a spring force acting in the direction of a valve seat, and are specified to be moved away from the valve seat by energizing with an opening control current counter to the spring force, and to bear on the valve seat by energizing with a heating control current that is less than the opening control current, wherein the coil is specified to heat the solenoid directional valve when the heating control current is applied. The possibility of heating the mentioned valves reduces the risk of frost damage to the pneumatic system as a whole. In addition to the sensor cleaning device and other compressed air consumers, this also relates in particular to the compressed air supply unit.

According to various embodiments, the control device is furthermore configured to selectively energize one, a plurality or all of the following solenoid directional control valves with an opening control current and a heating control current:
the at least one branch line switch valve,
the least one nozzle valve,
the at least one vent valve, and
the compressor vent valve.

The possibility of heating the mentioned valves reduces the risk of malfunctions of the pneumatic system as a result of freezing. In addition to the sensor cleaning device or other compressed air consumers, this also applies in particular to the compressed air supply system. The use of the already existing coil of the solenoid valves makes it possible to dispense with additional heating elements. It should be understood in this context that heating of the solenoid valves is necessary, especially before opening, since they remain in the closed state for longer periods of time. Damage to the valve only occurs when a valve subjected to icing, or its armature, is moved. Energizing the solenoid valve before it is actually opened prevents freezing due to heating of the valve, this preferably taking place or being maintained permanently during operation.

In a third aspect, the disclosure achieves the object mentioned at the outset by a vehicle. According to the third aspect, the disclosure proposes a vehicle, in particular a passenger automobile, with a compressed air supply system for supplying a compressed air consumer via a compressed air supply port. The compressed air supply system includes a compressed air provider for providing compressed air at a compressed air supply port, a pneumatic main line with an air dryer for drying and directing compressed air to the compressed air supply port in a filling direction, and a branch line emanating from the pneumatic main line in the filling direction upstream of the air dryer and reconnecting downstream of the air dryer. Furthermore, the vehicle includes a control device according to the second aspect of the disclosure, which is assigned to the compressed air supply system, and a compressed air consumer, in particular a sensor cleaning device connected to the compressed air supply port. As a result of such a control device, the vehicle assumes the advantages described with respect to the first aspect and the second aspect of the disclosure. Preferred embodiments and advantages according to the first aspect of the disclosure are likewise preferred embodiments and advantages of the vehicle according to the third aspect of the disclosure and vice versa.

According to various embodiments, the vehicle furthermore includes at least one sensor and/or a data interface, preferably a vehicle data bus, in particular CAN bus, which is connected for signals to the control device and is configured to provide sensor and/or memory data for determining a saturation level of the air dryer and/or an air humidity defined by at least one status variable. Thus, the controller can access necessary information regarding the saturation level of the air dryer and/or a humidity or temperature either directly via at least one sensor or via a corresponding data interface. In particular, this information allows a calculation or estimation of the saturation level of the air dryer. The air humidity of the ambient air, which is inducted and compressed by the compressed air provider, in particular a compressor, in conjunction with the permissible humidity content of the compressed air to be provided at the compressed air port, consequently also affects the saturation of the air dryer.

According to various embodiments, the vehicle furthermore includes an on-board network which is connected via the data interface to the control device and is configured to provide one, a plurality, or all of the following data: Location information of a navigation system, memory data of an on-board network memory, sensor information of at least one sensor connected to the on-board network, in particular a temperature sensor of a temperature sensor array and/or a humidity sensor and a compressed air sensor. Furthermore, the vehicle preferably includes an on-board network battery which is configured to provide a power supply for the on-board network and/or the compressed air consumer and/or the control device and/or the compressor. This means that a power supply for the components of the vehicle pertaining to the supply and control of the compressed air supply system is provided centrally via the on-board network battery. The disclosure advantageously takes into account, for example, that the compressor requires an increased energy requirement for the compression of the inducted compressed air.

Sensor information presently includes a temperature detected by a temperature sensor array and/or a pressure detected by a pressure sensor and/or an air humidity detected by an air humidity sensor.

Accordingly, a central power supply of the compressed air consumer via the on-board network battery is also advantageous. The compressed air supply system per se, or the electrically controllable pneumatic solenoid valves, are preferably supplied with a current via the control device. The actuation of the branch line switch valves can preferably take place by way of such energization or de-energization by the control device.

According to various embodiments, the control device is configured to determine, as a function of the data provided, the current and/or predicted temperature of the environment and/or the current and/or predicted humidity of the environment at least at one of the following positions: at a current location, along a route and at a destination. Via a correspondingly configured control device, the temperature and/or humidity of the environment can thus not only be determined at a current location, but also predictively along the route or at a destination. This allows for predictive regeneration of the air dryer, taking into account future environmental conditions. Such environmental conditions can particularly relate to low temperatures or very high air humidity. Thus, high ambient air humidity leads to increased humidity retention in the air dryer, or else low temperatures require the air dryer to be ready for operation.

### BRIEF DESCRIPTION OF DRAWINGS

The invention will now be described with reference to the drawings wherein:

FIG. 1 shows a compressed air supply system having an assigned control device according to the disclosure in a perspective view;

FIG. 2A schematically shows a vehicle with a compressed air supply system in a basic operating mode in a first embodiment;

FIG. 2B schematically shows the vehicle in accordance with FIG. 2A with the compressed air supply system in a first operating mode in a first embodiment;

FIG. 3 schematically shows a vehicle with an air supply system in a basic operating mode in a second embodiment;

FIG. 4. shows a schematic illustration of a vehicle with a compressed air supply system according to a third embodiment;

FIG. 5 shows a solenoid directional control valve for a vehicle in accordance with FIGS. 2A to 4;

FIG. 6A shows a first embodiment of a pneumatic assembly;

FIG. 6B shows a second embodiment of a pneumatic assembly;

FIG. 6C shows a third embodiment of a pneumatic assembly;

FIG. 6D shows a fourth embodiment of a pneumatic assembly;

FIG. 7 shows the sequence of a method for the control device 1300 of a compressed air supply system for a vehicle according to FIGS. 2A and 2B, according to a first embodiment;

FIG. 8 shows the sequence of a method for the control device 1300 of a compressed air supply system for a vehicle according to FIGS. 2A and 2B, according to a second embodiment; and,

FIG. 9 shows the sequence of a method for the control device 1300 of a compressed air supply system for a vehicle according to FIG. 3 according to a third embodiment.

### DETAILED DESCRIPTION

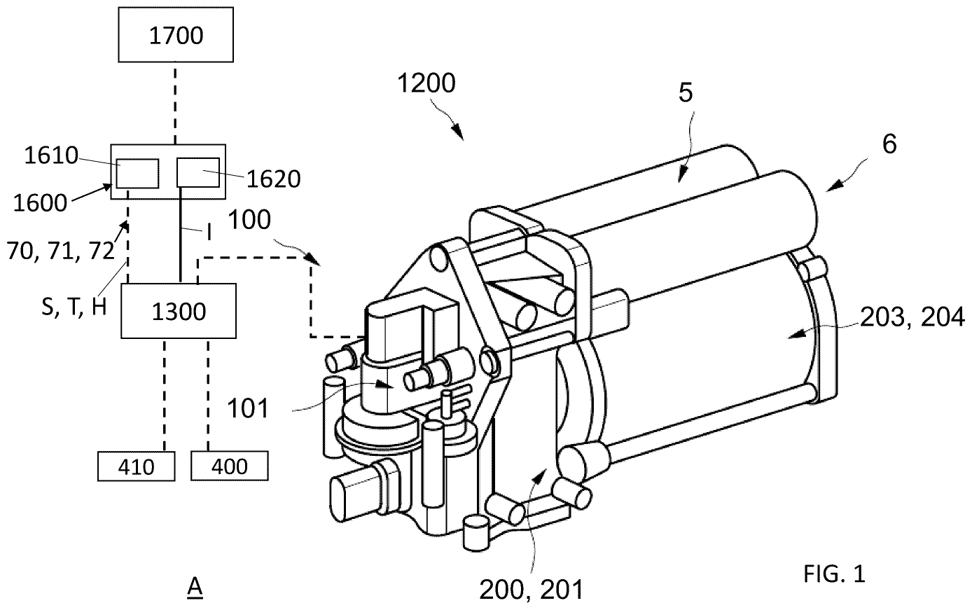

The compressed air supply system 1200 according to FIG. 1 includes a compressed air supply plant 100. Furthermore, the compressed air supply system 1200 includes a compressed air provider 200 which preferably includes a compressor 201 driven by an electric motor 203.

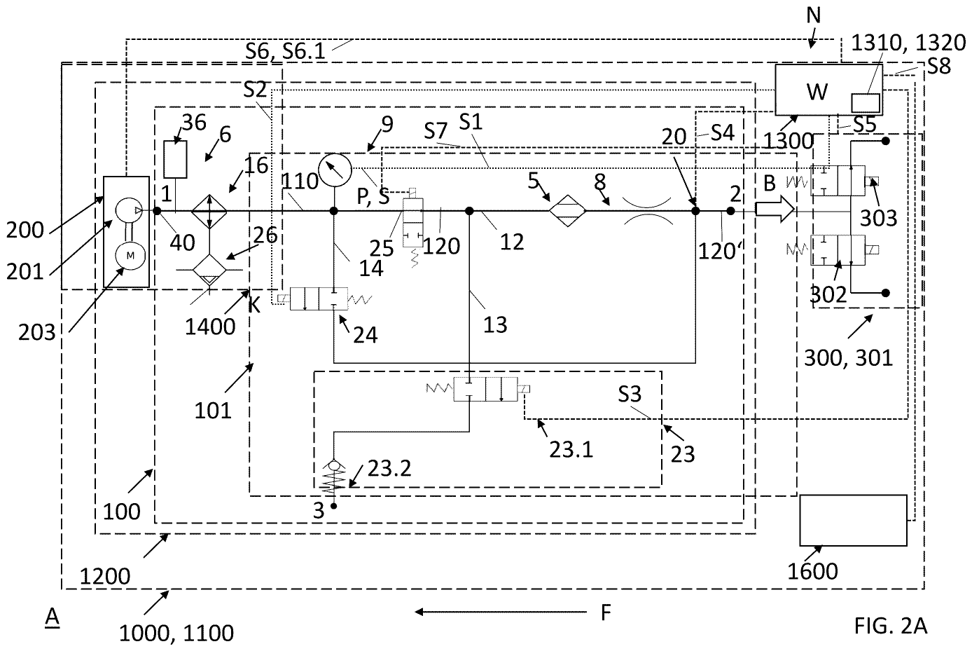

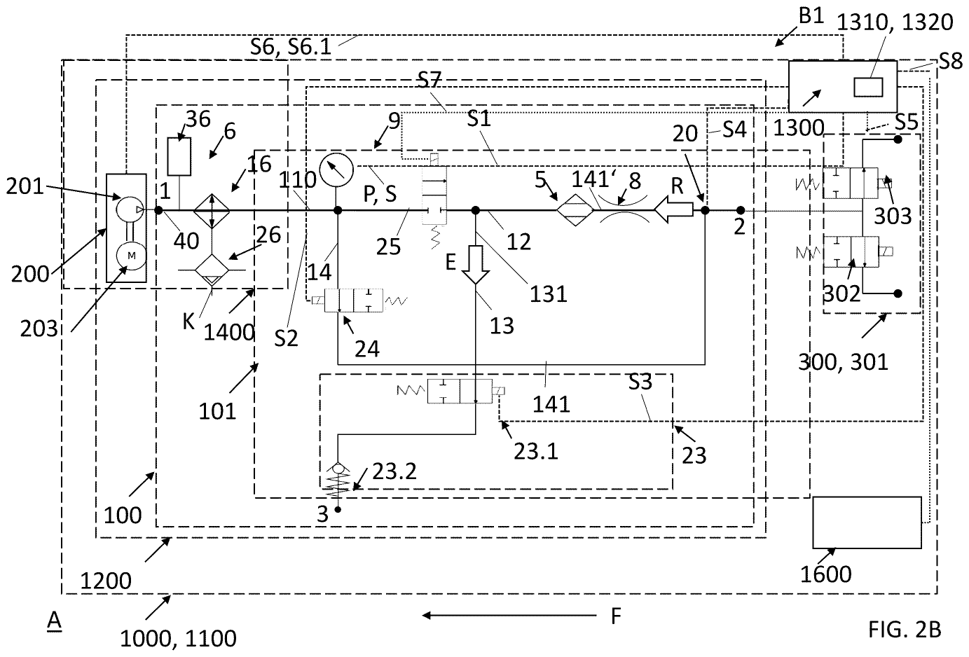

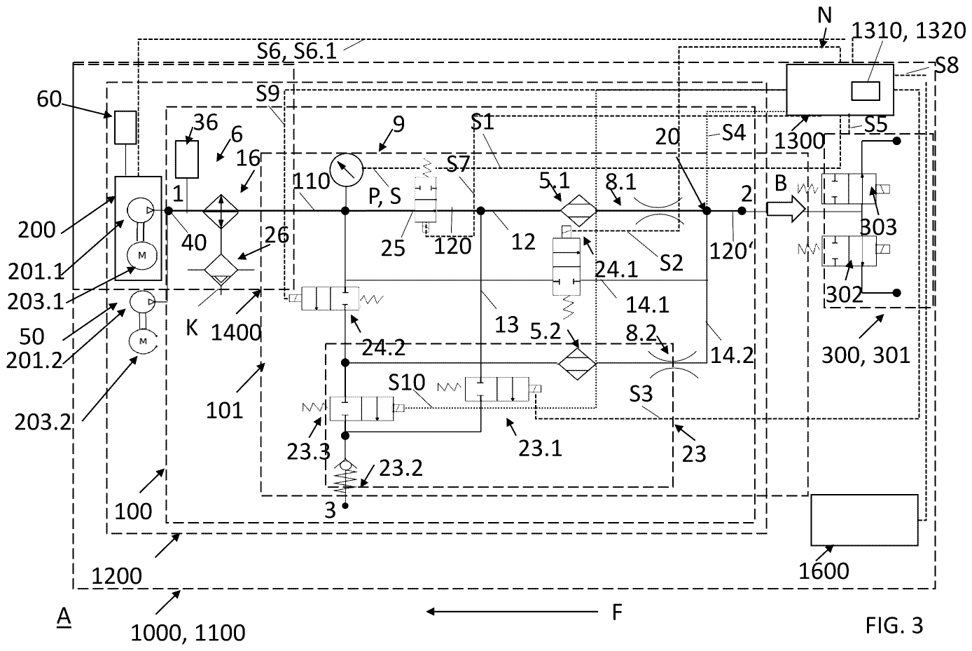

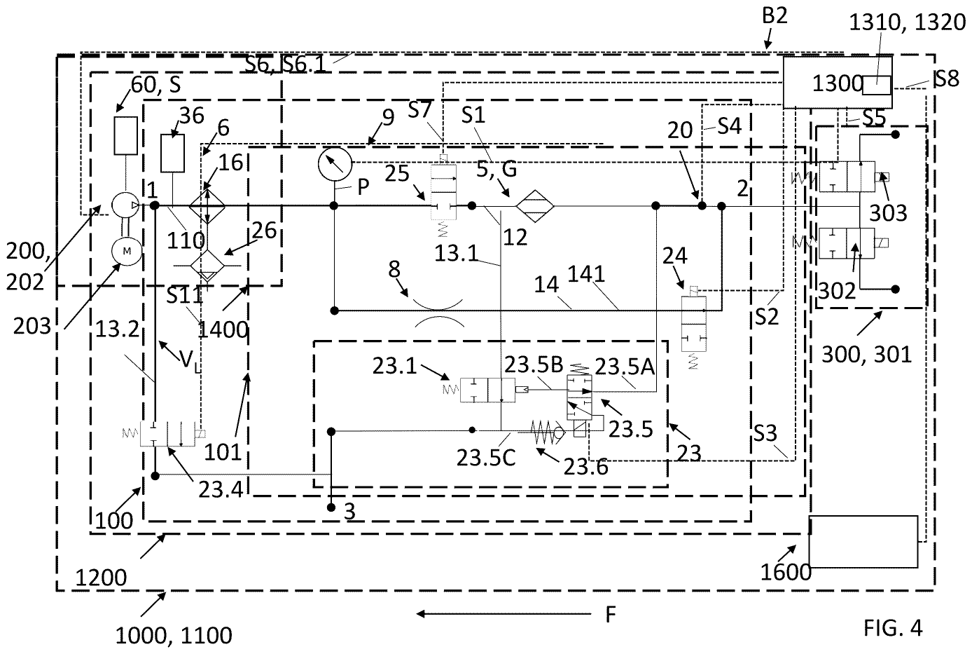

The compressed air provider 200 is connected via a compressed air port 1 (see FIGS. 2A and 2B) to the compressed air supply plant 100. The compressed air supply plant 100 includes an air dryer 5 which is disposed in a pneumatic main line 12 (see FIGS. 2A and 2B) and a water separator 6 (see FIGS. 3 and 4) which is fluidically disposed between the air dryer 5 and the compressed air port 1 (cf. FIGS. 2A and 2B). Furthermore, the compressed air supply plant 100 includes a pressure control module 101 which has a number of branch line switch valves (not shown) for distributing the pressure within the compressed air supply plant 100.

The compressed air supply system 1200 is assigned a control device 1300 for controlling the compressed air supply system 1200.

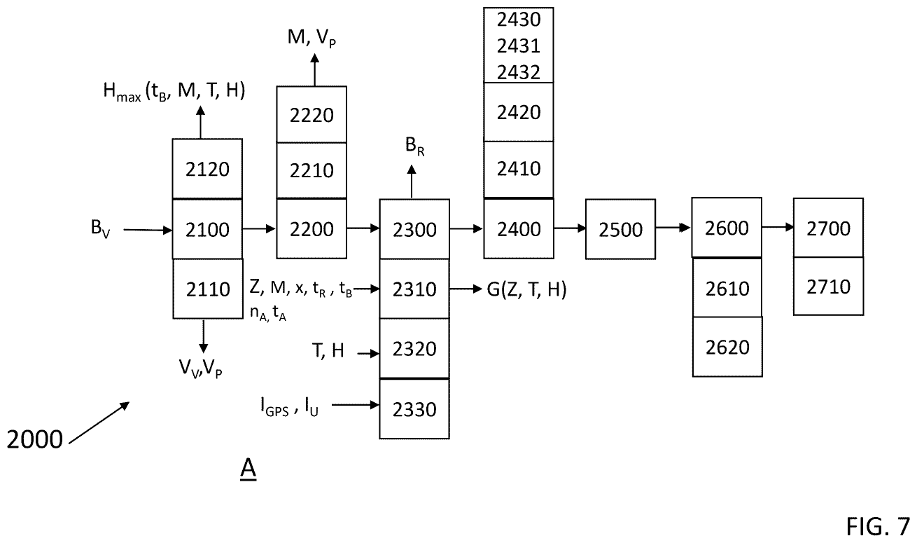

The control device 1300 is preferably connected for signals to an ambient temperature sensor 410 and an air humidity sensor 400, which are configured to transmit sensor information S, T, H (see FIG. 7) for determining a saturation level G (see FIG. 7) of the air dryer 5 and/or a permissible humidity Hₘₐₓ (see FIG. 7) of the compressed air to be provided at the compressed air supply port 2. Alternatively or additionally, a dew point sensor (for example, in the air dryer, not shown) for determining the saturation level G (see FIG. 7) of the air dryer 5 can be connected to the control device.

Furthermore, preferably at least one data interface 70, preferably a vehicle data bus 71, in particular a CAN bus 72 is connected for signals to the control device 1300 and is configured to provide stored sensor information S, T, H (see FIG. 7) for determining a saturation level G (see FIG. 7) of the air dryer 5 and/or a permissible humidity Hₘₐₓ (see FIG. 7). For this purpose, the data interface 70 connects the control device 1300 to an on-board network 1600 or a navigation system 1700. Alternatively, the connection to the navigation system 1700 can also be made indirectly via the on-board network 1600, wherein the on-board network 1600 accesses and/or receives location information I_{GPS} (see FIG. 7) from the navigation system 1700. The on-board network 1600 preferably includes an on-board network memory 1610 on which the sensor information S, T, H is stored. Furthermore, the control device 1300 is preferably specified to store a predefined value range W for a supply pressure V_{P} and/or a supply volumetric flow V_{V} and/or a permissible humidity content Hₘₐₓ and/or a status variable Z, which in the method shown in FIG. 7 to FIG. 9 is preferably accessed in step 2300 and/or step 4300.

The on-board network 1600 furthermore has an on-board network battery 1620, which is configured to supply the on-board network 1600 and/or the compressed air provider 200 and/or the compressed air consumer 300 (see FIG. 2A, FIG. 2B, FIG. 3 and FIG. 4) and/or the control device 1300 with a current I.

The functional mode of the control device 1300 is explained in detail in conjunction with the preferred embodiments of the vehicle 1000 shown in FIG. 2A, FIG. 2B, FIG. 3 and FIG. 4.

FIG. 2A shows a vehicle 1000, in particular a passenger automobile 1100. The passenger automobile 1100 includes a compressed air supply system 1200 as well as an electronic control device 1300 (ECU) and a compressed air consumer 300 which in the present case is a sensor cleaning device 301.

The compressed air supply system 1200 includes a compressed air supply plant 100 and a compressed air provider 200 connected via a compressed air port 1 to the compressed air supply plant 100. The compressed air provider 200 presently includes a compressor 201 with an electric motor 203.

The compressed air supply plant 100 includes a compressed air port 1 for connection to the compressed air provider 200 (see FIG. 1), and a compressed air supply port 2 for connecting the compressed air consumer 300. The compressed air port 1 is connected to the compressed air supply port 2 via a pneumatic main line 12. Furthermore, a vent line 13 to a vent port 3, which is specified to vent the pneumatic main line 12, emanates from the pneumatic main line 12. The compressed air supply plant 100 furthermore includes an air dryer 5 disposed in the pneumatic main line 12. The air dryer 5 is specified to dry the compressed air 110 supplied at the compressed air port 1 and directed in a filling direction B through the pneumatic main line 12.

Furthermore, a water separator 6 (cf. FIGS. 3 and 4) is disposed in the pneumatic main line 12 between air dryer 5 and compressed air port 1. The water separator 6 includes a condensation dryer 16 and a drainage element 26, preferably a drain valve, which are specified to discharge at least a portion of the humidity of the compressed air 110 provided at the compressed air port 1 as condensate K. The water separator 6 furthermore includes a ventilation apparatus 36. The ventilation apparatus 36 is disposed between the compressed air port 1 and the condensation dryer 16. Alternatively, the ventilation unit 36 can also be disposed in the filling direction B (see FIG. 2B) downstream of the condensation dryer 16.

The water separator 6 with the condensation dryer 16, the drainage element 26 and the ventilation apparatus 36 is preferably disposed in a front part 1400 of the vehicle 1000, when viewed in the direction of travel F. This means that the air stream occurring during operation can also be used to cool the compressed air compressed by the compressor 201. Thus, the saturation of the air dryer 5 is decelerated by the partially dehumidified compressed air 120 in the pneumatic main line 12.

Presently, a unit consisting of a number of components is understood to be a water separator 6, the function of which is to separate water from the compressed air or to facilitate this separation.

The compressed air supply plant includes a vent valve assembly 23. Disposed in the vent line 13 is a vent valve 23.1 (see FIG. 3) of the vent valve assembly 23, which is preferably an electrically controllable 2/2-way valve. Furthermore disposed in the direction of the vent line 13 downstream of the vent valve 23.1 (see FIG. 3) is preferably a vent check valve 23.2 of the vent valve assembly 23, which preferably opens in a pressure-controlled manner in the direction of the vent port 3. When the vent valve 23.1 is open, the vent check valve 23.2, as a consequence of the compressed air located in the vent line 13, thus preferably opens the vent line 13. At the same time, the vent check valve 23.2 prevents humidity from entering via the vent line 13. It should also be understood in this context that the vent line 13 can emanate at any position of the main line 12 upstream of the air dryer 5 in the filling direction B.

According to various embodiments, the compressed air supply plant 100 furthermore includes a throttle 8. The throttle 8 is preferably disposed downstream of the air dryer 5 in the filling direction B. The throttle 8 is specified to release the compressed air, which may have been recirculated for regenerating the air dryer 5.

Furthermore, a branch line 14 emanates from the pneumatic main line 12 between the water separator 6 and the air dryer 5, and reconnects to the pneumatic main line 12 between the air dryer 5 and the compressed air supply port 2. The branch line 14 has a branch line switch valve 24. The branch line switch valve 24 is preferably configured as an electrically controllable 2/2-way valve and selectively switchable in such a manner that the compressed air supply plant 100 can be operated in a basic operating mode N according to FIG. 2A and a first operating mode B1 according to FIG. 2B.

The compressed air supply plant 100 has the pressure control module 101 shown in FIG. 1. The branch line switch valve 24 and the vent valve 23.1 are assigned to the pressure control module 101.

Furthermore, the compressed air supply plant 100 includes a pressure sensor 9 which is disposed in the pneumatic main line 12 between the water separator 6 and the air dryer 5. The pressure sensor 9 is specified to detect an input pressure P in the pneumatic main line 12, thus the pressure of the humid compressed air 110 provided at the compressed air port 1 or of the compressed air 120 partially dehumidified by the water separator 6, and to provide a sensor signal S. The pressure sensor 9 is connected for signals via a first signal line S1 to the control unit 1300 which is thus configured to monitor the input pressure P.

Furthermore, the control device 1300 is connected via a second signal line S2 to the branch line switch valve 24 and via a third signal line S3 to the vent valve 23.1. Furthermore, the control device 1300 is connected via a fourth signal line S4 (see FIG. 3 and FIG. 4) to a pneumatic assembly 20 (cf. FIG. 3, and FIG. 4) assigned to the compressed air supply port 2.

The control device 1300 is specified to selectively release the switch valve 24 of the branch line 14 or the vent valve 23.1 (see FIG. 3 and FIG. 4) so as to selectively release the vent line 13.

Furthermore, the control device 1300 can preferably be specified to control the compressed air provider 200, as a function of the detected sensor signal S of the pressure sensor 9, so as to control the pressure in the pneumatic main line 12—at least in the filling direction B upstream of the throttle 8—and to limit the pressure to a maximum supply pressure V_{P}, preferably of 5 bar.

The control device 1300 is furthermore connected to the compressed air consumer 300 via a fifth signal line S5. The control device 1300 is specified to receive a supply demand B_{V} (see FIG. 7) of the compressed air consumer 300, preferably via the fifth signal line S5. According to various embodiments, receiving the supply demand B_{V} (cf. FIG. 7) via the fifth signal line S5 by the control device 1300 furthermore includes receiving a supply pressure P_{V} and/or a supply volumetric flow V_{V} (see FIG. 7). Alternatively or additionally, receiving the supply demand B_{V} (see FIG. 7) by the control device 1300 furthermore includes determining a permissible humidity content Hₘₐₓ of the compressed air 120′ to be provided at the compressed air supply port 2 by the control device 1300. For this purpose, the control device 1300 preferably includes a computing device 1310, in particular a processor 1320, which is used for determining the supply pressure P_{V} and/or the supply volumetric flow V_{V} and/or the permissible humidity content Hₘₐₓ as a function of the supply demand B_{V}. (see FIG. 7).

Furthermore, the control device 1300 is connected to the compressed air provider 200 via a sixth signal line S6. The control device 1300 is specified to monitor an operating time t_{B} of the compressed air provider 200, the latter presently including a compressor 201 with an electric motor 203. Furthermore, the control device 1300 is configured to monitor a motor speed M (cf. FIG. 7) of the electric motor 203. The electric motor 203 is preferably a BLDC electric motor 204 (see FIG. 1).

The signal lines S1, S2, S3, S4, S5, S6 can be configured to be wired or wireless. According to various embodiments, the signal lines S5, S6 each include a data interface, in particular a vehicle data bus or CAN bus. The signal line S6 is preferably embodied as CAN bus connection S6.1. The signal lines S2 and S3 can preferably also be merely electrical lines by way of which the control device 1300 actuates the branch line switch valve 24 or the vent valve 23.1 by energizing or de-energizing.

Furthermore, the control device 1300 is preferably configured to feedback-control the supply pressure P_{V} and/or the supply volumetric flow V_{V} of the compressed air 120′ provided at the compressed air supply port 2 as a function of the supply demand BV (see FIG. 7) of the compressed air consumer 300. For feedback-controlling the supply pressure P_{V} and/or the supply volumetric flow V_{V}, the control device 1300 is connected for signals to the pressure sensor 9 disposed in the pneumatic main line 12, the pressure sensor 9 being configured to detect the input pressure P in the pneumatic main line 12. According to various embodiments, the compressed air port 1 is furthermore assigned a pressure regulator 40 (see FIGS. 2A, 2B, 3 and 4) and the control device 1300 is configured to control the pressure regulator 40 for controlling the supply pressure P_{V} and/or the supply volumetric flow V_{V} as a function of the sensor signals S of the pressure sensor 9.

Alternatively or additionally, the control device 1300 is connected to the electric motor 203 via the sixth signal line S6 and for this purpose configured to feedback-control a motor speed M of the electric motor 203 so as to provide compressed air 120′with the supply pressure P_{V} and/or the supply volumetric flow V_{V} at the compressed air port 1.

The control device 1300 is configured to receive a supply demand B_{V} (see FIG. 7) of the compressed air consumer 300 preferably via the fifth signal line S5, and to actuate the compressor 201, in particular the electric motor 203 assigned to the compressor 201, for providing compressed air 110 at the compressed air port 1 when receiving a supply demand BV (see FIG. 7). Furthermore, the control device 1300 is configured to identify a regeneration implementation time B_{R} (see FIG. 7) of the air dryer 5 as a function of the supply demand B_{V} (see FIG. 7) and/or a saturation level of the air dryer 5 defined by at least one status variable which is defined by one or a plurality of status variables Z (see FIG. 7). The control device 1300 is configured to access via the sixth signal line S6 an operating time t_{B} of the compressor 201 as a status variable, and a number x of regenerations of the air dryer 5 and a period t_{R} since the last regeneration (see FIG. 7). The control device 1300 is preferably configured to determine this saturation level G as a function of the operating time t_{B} of the compressor 201, of the number x of regenerations of the air dryer 5 and of the period t_{R} since the last regeneration as well as the temperature T of the environment A and the humidity H of the environment A (see FIG. 7). The temperature T and the humidity H can preferably be provided as sensor information T, H.

According to various embodiments, the compressed air supply plant 100 furthermore includes a main line switch valve 25 disposed in the pneumatic main line 12. The control device 1300 is preferably connected to the main line switch valve 25 via a seventh signal line S7.

The vehicle 1000 further includes an on-board network 1600, which is connected for signals to the control device 1300 via an eighth signal line S8

FIG. 2A shows the compressed air supply system 1200 in a basic operating mode N. The compressed air supply system 1200 remains in the basic operating mode N in the event that the control device 1300 does not identify a regeneration implementation time B_{R}, but does identify a supply demand B_{V} (see FIG. 7). In basic operating mode N, the compressed air 110 provided at the compressed air port 1 is directed via the pneumatic main line 12 and dried by the air dryer 5 before being provided at the compressed air supply port 2. In this basic operating mode N, the branch line switch valve 24 blocks the branch line 14 due to being de-energized by the control device 1300. Furthermore, the control device 1300 controls the vent valve assembly 23 in such a manner that the vent valve 23.1 preferably blocks the vent line 13.

FIG. 2B shows the compressed air supply system 1200 in a first operating mode B1. The compressed air supply system 1200 is operated in this operating mode B1 in the event that the control device 1300 identifies a regeneration implementation time B_{R} (see FIG. 7) as a function of the supply demand B_{V} (see FIG. 7) and/or a saturation level G of the air dryer 5 defined by at least one status variable. In the event that the control device 1300 identifies such a regeneration implementation time B_{R}, it actuates the branch line switch valve 24 by energizing the latter. The branch line switch valve 24, which is configured as a 2/2-way valve which is closed when de-energized, then fluidically opens the branch line 14 in the filling direction B pneumatically, wherein the pneumatic main line 12 in the first operating mode B1 is configured to allow a recirculation of compressed air 141 from the branch line 14 counter to the filling direction B for regenerating the air dryer 5.

The control device 1300 is furthermore configured to actuate the vent valve assembly 23 for releasing the vent line 13 in the first operating mode B1 by energizing the vent valve assembly 23. The compressed air 131, directed counter to the filling direction B through the air dryer 6, can thus be discharged into the environment A after exiting the air dryer 5 via the vent port 3. In embodiments in which the compressed air supply system 1200, in particular the compressed air supply plant 100, has a main line switch valve 25 disposed in the pneumatic main line 12, the control device 1300 is furthermore configured to actuate the main line switch valve 25 for blocking the pneumatic main line 12. According to various embodiments, the main line switch valve 25 is formed as a de-energized closed 2/2-way valve, so that the main line switch valve blocks the pneumatic main line 12 in the event that the control device 1300 switches the main line switch valve 25 de-energized.

After the regeneration in the first operating mode B1 has been carried out or after the provision of compressed air 120′ at the compressed air supply port 2 in the basic operating mode N, the compressed air supply system 1200 can also be operated in a sleep mode (not shown), in the event that the control device 1300 does not identify a regeneration implementation time B_{R} (see FIG. 7), or receive a supply demand B_{V} (see FIG. 7). If this is the case, the control device 1300 is preferably configured to provide compressed air 110 at the compressed air port 1 for a further moment by actuating the compressor 201, which is used for flushing the pneumatic main line 12 and/or the branch line 14 with compressed air 120′, which is provided at the compressed air port 1, is routed via the corresponding lines 12, 13 and dried by the air dryer 5 and is finally discharged via the vent line 13 with the vent valve 23.1 open via the vent port 3. Thus, the pneumatic main line 12 and the branch line 14 are relieved of residues and in particular residual humidity. According to various embodiments, the control device 1300 after flushing the lines 12, 14 is configured to actuate the main line switch valve 25 and the branch line switch valve 24 for decoupling the respective line 12, 14 from the compressed air port 1 in such a manner that the pneumatic main line 12 and the branch line 14 are blocked in the filling direction B, so that a sleep mode is set.

The control device 1300, connected via the signal line S4 to the pneumatic assembly 20, is also preferably configured to distribute the compressed air 141 to the pneumatic main line 12 for regeneration of the air dryer 5 and to the compressed air supply port 2 by actuating the pneumatic assembly 20, in order to enable a simultaneous compressed air supply and regeneration.

FIG. 3 shows a second embodiment of the vehicle according to the disclosure. Identical or equivalent components presently have identical reference signs, and reference is made to the description of the first embodiment shown in FIGS. 2A and 2B. FIG. 3 shows the vehicle 1000 in basic operating mode N. The compressed air supply system 1200 of the vehicle 1000 differs from the first embodiment in that the branch line 14.1 is a first branch line 14.1 with a first branch line switch valve 24.1 and the compressed air supply system 1200, in particular the compressed air supply plant 100 thereof, furthermore includes a second branch line 14.2 with a second branch line switch valve 24.2. Furthermore, the air dryer 5.1 disposed in the pneumatic main line 12 is a first air dryer 5.1, and the compressed air supply plant 100 furthermore includes a second air dryer 5.2 disposed in the second branch line 14.2.

The control device 1300, as a function of the supply demand B_{V} (see FIG. 7) and a status variable, which characterizes the saturation level G of the second air dryer 5.2, is configured to identify a regeneration implementation time B_{R} (see FIG. 7) of the second air dryer 5.2.

The control device 1300, when identifying a regeneration implementation time B_{R} (see FIG. 7) of the second air dryer 5.2, is configured to actuate the main line switch valve 25 via a seventh signal line S7 and/or the first branch line switch valve 24.1 via the second signal line S2 for releasing the pneumatic main line 12 or the first branch line 14.1 in order to fluidically open the respective line 12, 14.1 pneumatically. The compressed air 120′, 141 directed in the main line 12 and/or the first branch line 14.1 in the filling direction B is then recirculated counter to the filling direction B through the second branch line 14.2 for regenerating the second air dryer 5.2 and discharged via the vent port 3. For discharge via the vent port 3, the control device 1300 is specified to actuate a second vent valve 23.2 in a second vent line 13.2 via a tenth signal line S10, so that the second vent line 13.2 is fluidically opened pneumatically.

The second embodiment of the vehicle 1000 as shown in FIG. 3 differs from the first embodiment in that the compressed air provider 200 includes a first compressor 201.1 with a first electric motor 203.1 and in that an additional compressed air source 50 which includes a second compressor 201.2 with a second electric motor 203.2 is furthermore provided. The compressed air supply system 1200 preferably furthermore includes a temperature sensor array 60, which is connected for signals to the control device 1300, for monitoring the temperature of the compressed air provider 200. According to various embodiments, the temperature sensor array 60 monitors the temperature of the first compressor 201.1 with the first electric motor 203.1. According to various embodiments, temperature sensor array 60 monitors the temperature of the compressed air source 50, in particular of the second compressor 201.2 with the second electric motor 203.2. The control device 1300 is configured to activate the second compressed air source 50 as required, as a function of the monitored temperature of the compressed air provider 200, and preferably deactivate the compressed air provider 200. In this way, overheating of the compressed air provider 200 can be detected at an early stage and operation can be maintained. Furthermore, the control device 1300, as a function of the supply demand B_{V} of the compressed air consumer 300, is configured to activate the second compressed air source 50 as required.

FIG. 4 shows a third embodiment of the vehicle 1000. For the avoidance of repetitions, reference is made to the description of the vehicle 1000 according to the first embodiment in FIGS. 2A and 2B and only points of differentiation will be discussed. Identical or equivalent components presently have identical reference signs.

Shown in FIG. 4 is a second operating mode B2 in which compressed air 141 from the branch line 14 is distributed to the pneumatic main line 12 for regeneration of the air dryer 5 and to the compressed air supply port 2 for supply to the compressed air consumer 300.

The third embodiment of the vehicle 1000 shown differs from the first embodiment in that the throttle 8, instead of being disposed in the pneumatic main line 12, is now disposed in the branch line 14 upstream of the branch line switch valve 24. The arrangement of the throttle in the branch line 14 results in a higher operating pressure which is advantageous for the air dryer in the case of air being directed through the branch line 14, when sized correspondingly. The throttle 8 relaxes the compressed air 141 provided at the compressed air port 1 at the start of the branch line 14, whereby the compressed air 141 is drier due to the lower air pressure. Thus, the branch line 14 and the branch line switch valve 24 disposed in the latter as well as the downstream components are protected against frost-related malfunctions. At the same time, in the case of the recirculation of the compressed air 141 through the pneumatic main line 12 counter to the filling direction B, relaxation necessary for regeneration of the air dryer 5 is achieved by the throttle 8.

Furthermore, a main line switch valve 25 is disposed in the pneumatic main line 12.

The vent valve assembly 23 includes a control valve 23.5 in the form of a 3/2-way solenoid valve. Furthermore, the vent valve 23.1 is configured as a pneumatically activatable vent valve 23.1. The control valve 23.5 can be actuated via electrical control signals in the form of a voltage and/or current signal. When actuated by the controller 1300 via an eleventh signal line S11, the control valve 23.5 can be transferred from a de-energized closed position to a pneumatically open position (not shown) in which a pressure derived via a pneumatic control line 23.5A from the pneumatic main line 12 for the pneumatic control of the controllable vent valve 23.1 is transmitted via a bypass 23.5B.

The non-return protection valve 23.6 protects the 3/2-way valve 23.5 on the one hand against water ingress from the environment and on the other hand prevents undesired opening of the pneumatically controlled vent valve 23.1 when actuating the compressor vent line 13.3.

When closed, the control valve 23.5 disconnects the control line 23.5A and is pneumatically connected to the vent port 3 via another pneumatic line 23.5C.

The vent line 13.1 is presently a first vent line 13.1, and the compressed air supply plant 100 furthermore includes a compressor vent line 133. The compressor vent line 13.3 emanates from the pneumatic main line 12 upstream from the main line switch valve 25 in the filling direction B. The vent valve assembly 23 has a compressor vent valve 23.4 in the compressor vent line 13.3. A line volume V_{L} between the compressed air provider 200, preferably a compressor 202 in the present case, and the branch line switch valve 24 and the main line switch valve 25 can be vented through the compressor vent line 13.3. The starting resistance for the compressor 202 is thus reduced.

The vent valve 23.1, the compressor vent valve 23.4 and the branch line switch valve 24 and the main line switch valve 25 are presently configured as solenoid valves, in particular solenoid valves that are closed when de-energized.

According to various embodiments, the compressed air supply system 1200 in the embodiments according to FIGS. 2A, 2B, 3 and 4 furthermore includes a temperature sensor array 60 for monitoring the temperature of the compressed air provider 200 and/or the compressed air source 50, wherein the temperature sensor array 60 is connected for signals to the control device 1300 and is configured to provide sensor signals S.

The compressed air consumer 300, which is presently a sensor cleaning device 301, furthermore includes a first nozzle valve 302 and a second nozzle valve 303. The nozzle valves 302, 303 are likewise solenoid valves, in particular solenoid directional valves, which are closed when de-energized.

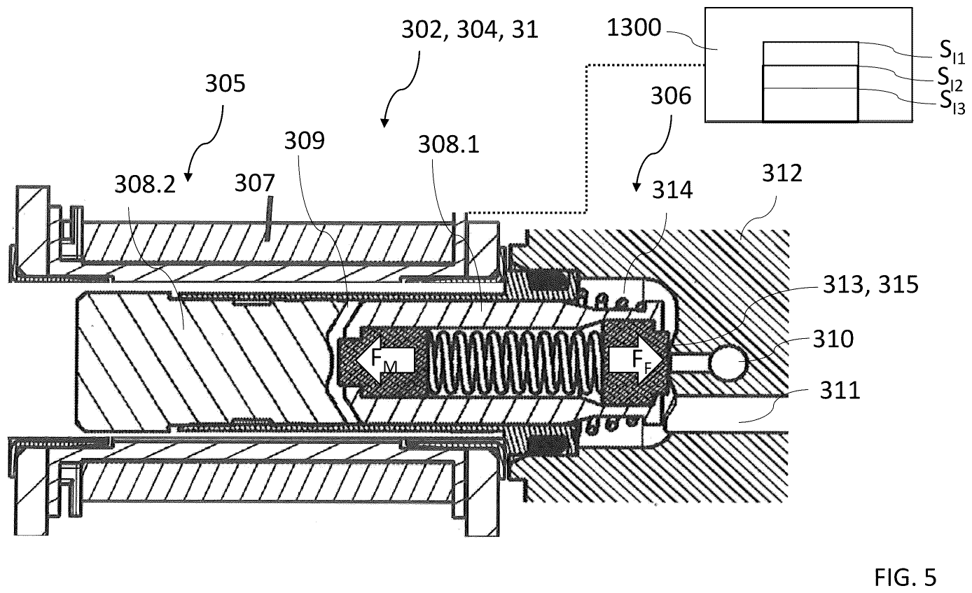

Such a solenoid directional valve is shown by way of example in FIG. 5 with reference to a possible configuration of a nozzle valve 302. The nozzle valve 302 is a 2/2-way valve 304 that is closed when de-energized. The nozzle valve 302 includes a magnetic part 305 and a pneumatic part 306. The magnetic part 305 has an electric coil 307, an armature 308.1, which is actuatable magnetically and under the influence of a spring force, and a fixed magnetizable core 308.2. Formed between the armature 308.1 and the core 308.2 is an air gap 309 which defines the possible stroke of the armature 308.1.

The pneumatic part 306 includes a first compressed air passage 310, a second compressed air passage 311. The pneumatic part 306 furthermore includes a valve plunger part 312 which has a contact surface 313 pointing in the direction of the armature 308.1.

The nozzle valve 302 furthermore includes a valve spring 314 which is configured to apply a spring force F_{F} in the direction of the valve plunger part 312, in particular the contact surface 313, to the armature 308.1. When the nozzle valve 302 is open, the armature 308.1 is spaced apart from a valve seat 315 of the pneumatic part 306.

The armature 308.1 is movably received in the magnetic part 305 and the pneumatic part 306. By energizing the electric coil 307, the latter generates a magnetic field with a magnetic force F_{M}. The resulting magnetic field generates a magnetic pole at the core 308.2, which attracts the armature 308.1 and moves the latter counter to the spring force F_{F} of the valve spring 314 away from the valve seat 315, so that the first compressed air passage 310 and the second compressed air passage 311 are fluidically connected. The magnitude of the magnetic force F_{M} depends on the applied control current S_{I} which is provided by the control device 1300. The opening control current S_{I1} required for opening the nozzle valve 302 exceeds the holding control current S_{I2} required for holding the nozzle valve 302 in the open position. The magnitude of the force that a magnetic field induced by the coil 307 applies to the armature 308.1 at a constant current is a function of the distance of the armature 308.1 relative to the magnetic field, that is, the size of the air gap 309 between armature 308.1 and core 308.2. At a larger distance, a weaker magnetic field is therefore effective. In the closed position, the armature 308.1 first has a greater distance to the magnetic field, so that an increased current, namely an opening control current S_{I1}, is provided. The opening control current S_{I1} required for opening the nozzle valve 302 refers to the current necessary to reduce the distance of the armature 308.1 to the core 308.2 and thus the air gap 309. As soon as the armature 308.1 moves to an open position, its distance to the magnetic field is reduced and a lower holding control current S_{I2} is sufficient to hold the armature 308.1 in this position. According to various embodiments, the control device 1300 is furthermore configured to apply a heating control current S_{I3} to the nozzle valve 302, which is less than the opening control current S_{I1}, in particular also less than the holding control current S_{I2}, such that the nozzle valve 302 is heated by the generated magnetic field in the closed state.

The control device 1300 shown in FIG. 2A to FIG. 4, so as to open the compressor vent valve 23.4 and the branch line switch valve 24, the main line switch valve 25 and the nozzle valves 302, 303, is configured to provide a control current S_{I} equal to the magnitude of the opening control current S_{I3} (see FIG. 5). Furthermore, the control device 1300 is also configured to impinge one, a plurality, or all of these valves with a heating control current S_{I3}.

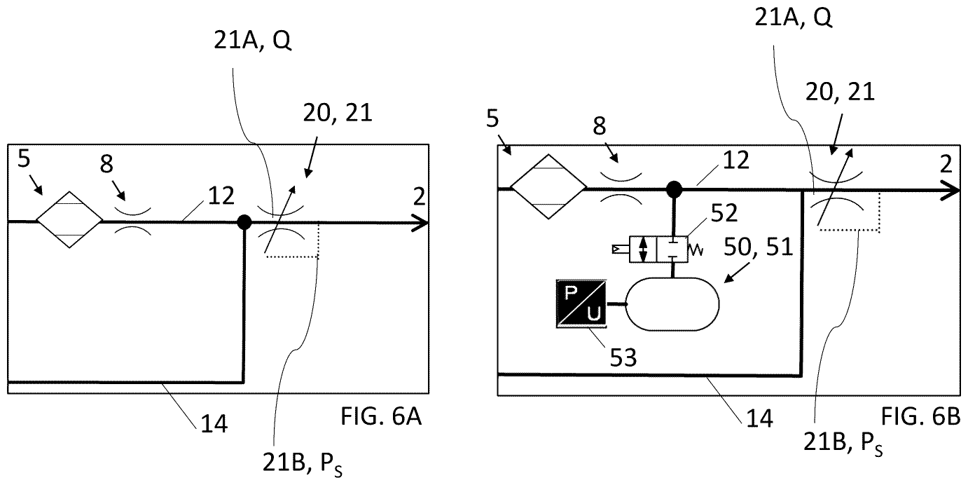

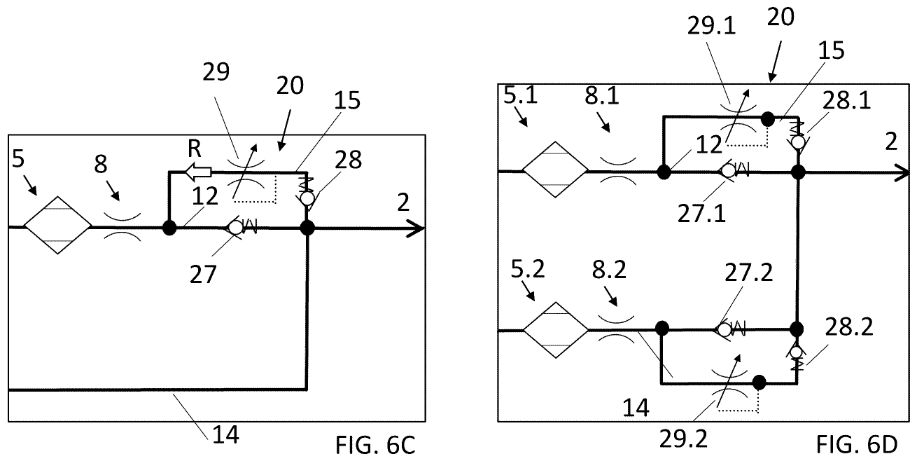

FIGS. 6A to 6D show a fragment of the compressed air supply system 1200 according to FIGS. 2A, 2B, wherein different embodiments of the pneumatic assembly 20 are shown in detail. For the avoidance of repetitions and in order to explain the operation of the pneumatic assembly 20, reference is therefore made to the description of FIG. 2A, FIG. 2B, FIG. 3 and FIG. 4 and in particular the description of the second mode of operation as in FIG. 1. The pneumatic assembly 20 according to FIG. 6A to FIG. 6D, in a second operating mode B2, as shown in FIG. 4, allows a distribution of the compressed air 141 directed in the branch line 14, 14.1, 14.2 as a function of the supply demand B_{V} and the identified regeneration implementation time B_{R} to the pneumatic main line 12 for recirculation counter to the filling direction B and to the compressed air supply port 2.

The pneumatic assembly 20 according to FIG. 6A includes a controllable throttle valve 21 which is configured to throttle compressed air supplied to the compressed air supply port 2 in the filling direction B. The throttle valve 21 has a variable flow cross section Q and for control, that is, for signal transmission, is connected to the control device 1300 (see FIG. 2A or 2B). The control device 1300 is configured to actuate the throttle valve 21 for changing the flow cross section Q in order to throttle the pressure in the pneumatic main line 12 to a supply pressure to be provided, the latter being in particular 5 bar. The throttle valve 21 has a throttle point 21A with a variable flow cross section Q, wherein the throttle valve 21 has a control pressure line 21B for directing a control pressure P_{S} and is configured to control the flow cross section Q as a function of the control pressure P_{S}.

The pneumatic assembly 20 according to FIG. 6B, in a manner analogous to that of the embodiment shown in FIG. 6A, includes a controllable throttle valve 21. Furthermore, the compressed air supply system 1200 includes an additional compressed air source 50 next to the compressed air provider 200, which in FIG. 3 is configured as a compressor 201. The compressed air source 50 includes a reservoir 51 for storing compressed air, wherein the reservoir is connected to the pneumatic main line 12 via a reservoir switch valve 52. The compressed air source 50 is configured to be connected to the pneumatic main line 12 as required, by actuating the reservoir switch valve 52. The control device 1300 (cf. FIG. 2A or 2B) is connected for signals to a reservoir pressure sensor 53 and is configured to actuate the reservoir switch valve 52. By actuating the reservoir switch valve 52, a defined amount of compressed air can be directed into the pneumatic main line 12, wherein the control device 1300 feedback-controls the amount of pressure via the signals of the reservoir pressure sensor 53.

The pneumatic assembly 20 according to FIG. 6C includes a pair of check valves 27, 28 that open in a mutually opposing manner and are fluidically connected in parallel, the pair being disposed between the air dryer 5 and the compressed air supply port 2.

The pair of check valves 27, 28 includes a first check valve 27 which opens in the filling direction B and is disposed in the pneumatic main line 12, and furthermore a second check valve 28 which opens in the recirculation direction R. The second check valve 28 is disposed in a bypass line 15 which forms a bypass about the first check valve 27. The pneumatic assembly 20 furthermore includes a recirculation throttle valve 29 disposed in the recirculation direction R downstream of the second check valve 28.

The pneumatic assembly 20 according to FIG. 6D is configured for use with compressed air supply plants as shown in FIG. 3, that is, for compressed air supply plants with two air dryers 5.1, 5.2. A first pair of check valves 27.1, 28.1 that open in a mutually opposing manner and are fluidically connected in parallel and have a corresponding recirculation throttle valve 29.1, as described with reference to the embodiment according to FIG. 6C, is assigned to the first air dryer 5.1 and disposed between the first air dryer 5.1 and the compressed air port 2.

A second pair of check valves 27.2, 28.2 that open in a mutually opposing manner and are fluidically connected in parallel and have a corresponding second recirculation throttle valve 29.2, as described with reference to the embodiment according to FIG. 6C, is assigned to the second air dryer 5.2 and disposed between the second air dryer 5.2 and the compressed air port 2.

FIGS. 7-9 schematically show the sequence of a control method 2000, 3000, and 4000.

The control method 2000 shown in FIG. 7 includes in a first step 2100 receiving a supply demand B_{V} of the compressed air consumer 300 by the control device 1300. Receiving the supply demand B_{V} according to the first step 2100 furthermore preferably includes as a sub-step 2110 determining or receiving a supply pressure V_{P} and/or a supply volumetric flow V_{V} of the compressed air 120′, 141 to be provided at the compressed air supply port 2 by the control device 1300, and preferably furthermore determining a permissible humidity content Hₘₐₓ of the compressed air to be provided at the compressed air supply port 2 by the control device 1300 in a further sub-step 2120.

The permissible humidity content Hₘₐₓ is determined in step 2110 preferably as a function of a temperature T and/or air humidity H of an environment, which is detected in particular via at least one temperature sensor array and/or an air humidity sensor.

Furthermore, the permissible humidity content Hₘₐₓ is determined in step 2110 preferably as a function of an operating time t_{B} of the compressed air provider 200, in particular of the electric motor 203, which is monitored via a signal-conducting connection, in particular via a CAN bus connection S6.1, by the control device 1300.

Furthermore, the permissible humidity content Hₘₐₓ is preferably determined in step 2110 as a function of a motor speed of the motor 203, in particular a BLDC electric motor 204, which is monitored via a signal-conducting connection, in particular via a CAN bus connection S6.1, by the control device 1300.

In a second step 2200, the method includes actuating the compressor 201 by the control device 1300 for providing compressed air at the compressed air supply port 1, should the control device 1300 receive a supply demand B_{V}. According to various embodiments, the second step furthermore includes feedback-controlling 2210 the supply pressure V_{P} and/or the supply volumetric flow V_{V} of the compressed air 120′, 141 to be provided at the compressed air supply port 2 by the control device 1300 as a function of the supply demand B_{V}. The control device 1300 is connected for signals to at least one pressure sensor 9 disposed in the pneumatic main line 12 for providing sensor signals S pertaining to an input pressure P, and to a pressure regulator 40 assigned to the pneumatic main line 12 and/or to the compressed air port 2. Feedback-controlling the supply pressure 2210 preferably includes controlling the pressure regulator 40 by the control device 1300 as a function of the sensor signals S. Additionally or alternatively, the control device 1300 is connected for signals to the electric motor 203, in particular BLDC electric motor 204, and feedback-controlling the supply pressure 2210 includes feedback-controlling 2220 a motor speed M of the electric motor 203 by the control device 1300.

Furthermore, actuating the compressor 201 in step 2200 preferably includes actuating an additional compressed air source 50 as required, such as shown in FIG. 3 or 6b. Actuating an additional compressed air source 50 is presently understood to mean connecting and/or activating the compressed air source 50 to or with the pneumatic main line 12. By an additional compressed air source 50, which may be an additional compressor 201.2 and/or a reservoir 51, the available compressed air quantity, that is, the available volumetric flow rate, is increased and it is possible to respond to variable system requirements. The control device 1300 controls in step 2220 the compressed air source 50 as a function of the supply demand B_{V} of the compressed air consumer 300 and/or of a temperature of the compressed air provider 200 detected by the temperature sensor array 60, or of a saturation level G of one of the air dryers 5 or of a first air dryer 5.1, monitored by the control device 1300.

Furthermore, the method 2000 includes in a third step 2300 identifying a regeneration implementation time B_{R} by the control device 1300 as a function of the supply demand B_{V} and/or a saturation level G of the air dryer 5 or the first air dryer 5.1 defined by at least one status variable Z. Furthermore, the status variables used in the third step 2300 for identifying a regeneration implementation time B_{R} preferably include an operating time t_{B} of the compressor 201 or a number x of regenerations of the air dryer 5, 5.1 or a period t_{R} since the last regeneration. Particularly according to various embodiments, identifying the regeneration implementation time B_{R} as sub-step 2310 includes calculating a saturation level G as a status variable Z as a function of the operating time t_{B} of the compressor 201 and/or of the motor speed M of the electric motor 203, and/or of the number x of regenerations and/or of the period t_{R} since the last regeneration and/or of the temperature T and/or humidity H of the environment A and/or of an activation number nA and/or activation time tA of the branch line switch valve 24, 24.1, 24.2 and/or of a main line switch valve 25 disposed in the pneumatic main line 12. The temperature T and/or the humidity H of the environment A, which are used according to step 2310 for calculating the saturation level G as the current and/or future saturation level G as the status variable Z, presently refer to temperatures or air humidity at a current location and/or a destination and/or along the route, wherein in sub-step 2320 the current temperature T and/or air humidity H are accessed by the control device 1300, and in a sub-step 2330 location information I_{GPS} and environmental information I_{U} assigned thereto can be retrieved by the control device 1300. Location information is in particular understood to also be GPS data accessed or made available by the navigation system.

Should a regeneration implementation time B_{R} be identified, the supply pressure V_{P} and/or the supply volumetric flow V_{V} and/or the permissible humidity content Hₘₐₓ and/or the status variable Z lie outside a value range W stored in the control device 1300 (see FIG. 2A to FIG. 4).

Furthermore, the method 2000 in a fourth step 2400 includes actuating the switch valve 24, 24.1, 24.2 by the control device 1300 for fluidically opening the branch line 14, 14.1, 14.2 pneumatically in a first operating mode B1, should the control device 1300 identify a regeneration implementation time B_{R}, and actuating or de-energizing the branch line switch valve 24, in particular of the first 24.1 branch line switch valve and/or the second branch line switch valve 24.2 for blocking the branch line 14, in particular the first branch line 14.1 and/or the second branch line 14.2, in the basic operating mode N, should the control device 1300 not identify a regeneration implementation time B_{R}, but identify a supply demand.

According to various embodiments, the fourth step 2400 as a sub-step 2410 includes actuating 2410 the vent valve 23.1 by the control device 1300 for releasing the vent line 13 emanating from the pneumatic main line 12 upstream of the air dryer 5, 5.1 in the filling direction B to a vent port 3, should the control device 1300 identify a regeneration implementation time B_{R}.

According to various embodiments, the fourth step 2400 as a sub-step 2420 includes actuating or de-energizing the main line switch valve 25 by the control device 1300 for blocking the pneumatic main line 12 in a first operating mode B1, should the control device 1300 identify a regeneration implementation time B_{R}, and actuating the main line switch valve 25 for the fluidically opening of the pneumatic main line 12 pneumatically in the basic operating mode N, should the control device 1300 not identify a regeneration implementation time B_{R}, but identify a supply demand.

According to various embodiments, the fourth step 2400 as a sub-step 2430, preferably in addition to sub-step 2410 and/or sub-step 2420, includes actuating the pneumatic assembly 20 by the control device 1300 for distributing the compressed air 141 directed in the branch line 14, 14.1, 14.2 as a function of the supply demand B_{V} and of the identified regeneration implementation time B_{R} to the pneumatic main line 12 for recirculation counter to the filling direction B and to the compressed air supply port 2. In this case, the compressed air supply system is operated in a second operating mode B2. Actuating the pneumatic assembly 20 preferably includes actuating 2341 a throttle valve 21 according to FIG. 6A or 6B for feedback-controlling the supply pressure V_{P} at the compressed air supply port 2 or actuating 2432 a recirculation throttle valve 29, 29.1, 29.2 for feedback-controlling the pressure of the compressed air recirculated counter to the filling direction B.

By actuating the branch line switch valve, compressed air 141 from the branch line 14, 14.1, 14.2 is recirculated in a fifth step 2500 counter to the filling direction B through the pneumatic main line 12 for regenerating the air dryer 5 or the first air dryer 5.1 in the first operating mode B1.

Furthermore, the method 2000 in a sixth step 2600 preferably includes flushing the pneumatic main line 12 and/or the branch line 14, 14.1, 14.2 via compressed air 120′provided at the compressed air port 1 and dried by the air dryer 5, and discharging the compressed air 120′ via the vent line 13. Alternatively or additionally as a sub-step 2610, the method furthermore includes flushing 2610 the compressed air consumer 300 via compressed air 120′provided at the compressed air port 1 and preferably dried by the air dryer 5, and discharging the compressed air 120′via the compressed air consumer 300.

According to various embodiments, the method 2000 furthermore includes, in a further sub-step 2620 of the sixth step 2600, actuating the compressor vent valve 23.4 for venting a line volume between the compressor 201 and the branch line switch valve 24, 24.1, 24.2 and the main line switch valve 25. Alternatively, venting can also be carried out before the second step 2200, that is, before actuating the compressor 201.

The method 2000 furthermore preferably includes in a seventh step 2700 actuating the main line switch valve 25 and the branch line switch valve 24, 24.1, 24.2 for pneumatically decoupling the pneumatic main line 12, in particular the air dryer 5 and the first air dryer 5.1, such that the main line switch valve 25 blocks the pneumatic main line 12, in such a manner that, for decoupling the branch line 14, 14.1, 14.2 from the compressed air port 1, the branch line switch valve 24, 24.1, 24.2 blocks the branch line 14, 14.1, 14.2. In the seventh step 2700, the compressed air supply plant 100 is thus depressurized. When the system is operated again, the compressed air supply plant 100 thus starts up in a depressurized state when actuating the compressed air provider 200 in step 2200.

According to various embodiments, the method 2000 in a sub-step 2710 of the seventh step additionally includes actuating 2710 the vent valve 23.1 for the pneumatic decoupling of the compressed air supply plant 100 from the compressed air provider 200 and the environment.

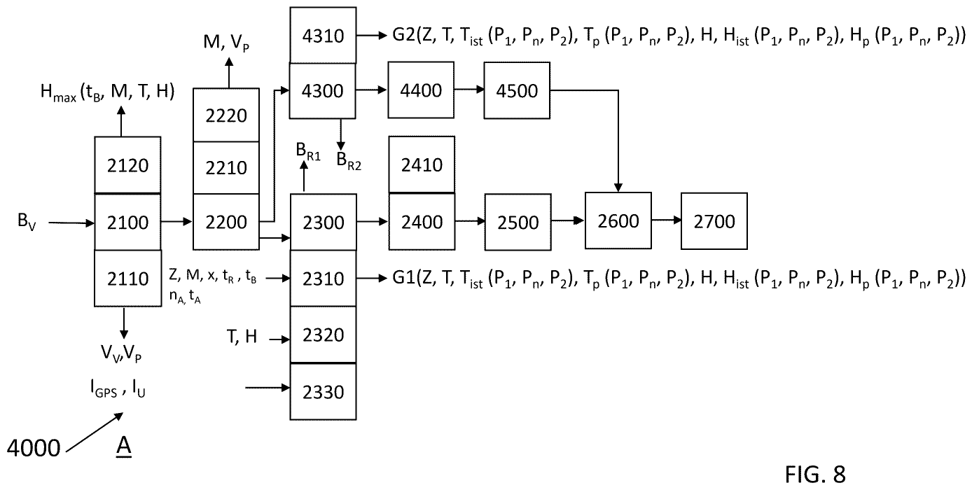

FIG. 8 shows a second embodiment of the method 3000 according to the disclosure. Identical or equivalent method steps presently have identical reference signs, and reference is made to the description of the method shown in FIG. 7, and only points of differentiation will be discussed.

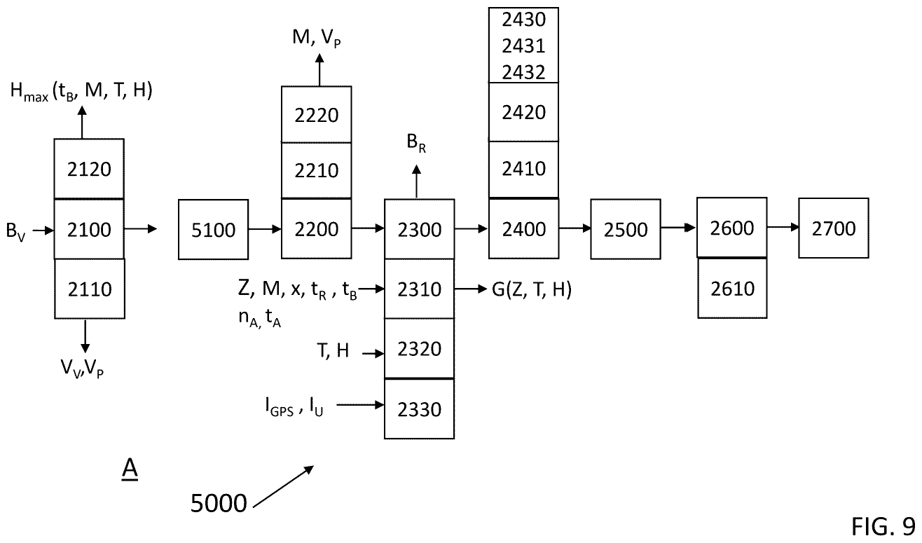

FIG. 8 shows a third embodiment of the method 4000 according to the disclosure for controlling a compressed air supply system, as shown in FIG. 3. Identical or equivalent method steps presently have identical reference signs, and reference is made to the description of the method shown in FIG. 7, and only points of differentiation will be discussed. The embodiment shown in FIG. 9 differs from the method 2000 described above and schematically shown in FIG. 7 in that the control device 1300, subsequent to second step 2200, identifies either in third step 2300 a regeneration implementation time B_{R} of the air dryer 5. If the air dryer is a first air dryer 5.1 and the compressed air supply plant 100 has a second air dryer 5.2, in third step 2300 a first regeneration implementation time B_{R1} of the first air dryer 5.1 is identified, or subsequently identifying 4300 second regeneration implementation time B_{R2} of the second air dryer 5.2 by the control device 1300 takes place, as a function of the supply demand B_{V} and/or of a saturation level G of the second air dryer 5.2. Identifying 4300 a second regeneration implementation time B_{R2} of the second air dryer 5.2 preferably includes in an analogous manner steps 2320 and 2330 which have been described in the context of identifying the regeneration implementation time B_{R} of the air dryer 5, or of the first regeneration implementation time B_{R1} of the first air dryer 5.1, respectively.

Should the supply pressure V_{P} and/or the supply volumetric flow V_{V} and/or the permissible humidity content Hₘₐₓ and/or the status variable Z lie outside a value range W stored in the control device 1300 (see FIG. 2A to FIG. 4), a second regeneration implementation time B_{R2} is identified.

In a sub-step 4310, deviating from sub-step 2310, however, a second saturation level G2 of the second air dryer 5.2 is determined.

Determining the first saturation level G1 in sub-step 2310 preferably takes place as a function of a current temperature Tᵢₛₜ and/or of a predicted temperature Tₚ of the environment A and/or of a current humidity Hᵢₛₜ and/or of a predicted humidity Hₚ of the environment A, which is determined on the basis of the provided sensor information S, T, H and/or location information I_{GPS} and/or the environmental information I_{U} at least at one of the following positions: at a current location P1, along a route Pn and at a destination P2.

Accordingly, determining the second saturation level G2 in sub-step 4310 preferably takes place as a function of a current temperature Tᵢₛₜ and/or of a predicted temperature Tₚ of the environment A and/or of a current humidity Hᵢₛₜ and/or of a predicted humidity Hₚ of the environment A, which is determined on the basis of the provided sensor information S, T, H and/or location information I_{GPS} and/or the environmental information I_{U} at least at one of the following positions: at a current location P1, along a route Pn and at a destination P2.

Furthermore, according to the third embodiment, the method 4000 includes selectively actuating 4400 the first branch line switch valve 24.1 and/or the main line switch valve 25 by the control device 1300 for fluidically opening the first branch line 14.1 and/or the pneumatic main line 15 pneumatically, should the control device 1300 identify a regeneration implementation time B_{R} of the second air dryer 5.2.

Furthermore, the method 4000 according to the third embodiment includes recirculating 4500 compressed air 141 from the first branch line 14.1 and/or the pneumatic main line 12 counter to the filling direction B through the second branch line 14.2 for regenerating the second air dryer 5.2.

The remaining method steps described with reference to the first embodiment, in particular the sixth step 2600 to seventh step 2700, may preferably also follow the recirculation of compressed air for regeneration through the second branch line 14.2 or the pneumatic main line 12 of the respective air dryer 5.1, 5.2.

FIG. 9 shows a fourth embodiment of the method 5000 according to the disclosure for controlling a compressed air supply system, as shown in FIG. 3. Identical or equivalent method steps presently have identical reference signs, and reference is made to the description of the method shown in FIG. 7, and only points of differentiation will be discussed. The method 5000 includes the first step 2100 to seventh step 2700 of method 2000 according to FIG. 7. The method 5000 prior to actuating the compressor 201 by the control device 1300 for providing compressed air at the compressed air supply port 1, in the second step 2200 furthermore includes in step 5100, energizing at least one of the branch line switch valves 24, 24.1, 24.2, one of the nozzle valves 302, 303 of a sensor cleaning device 301 connected to the compressed air supply plant 100 according to FIG. 4, one of the vent valves 23, 23.1, 23.3, and the compressor vent valve 23.4 with a heating current SI3. Thus, the valves can be heated first before they are energized with an opening current SI1 to release the respective flow path.

In the context of the disclosure, it should be understood that the first operating mode B1 describes a bypass mode in which undried or partially dehumidified compressed air is conveyed to the compressed air supply port 2 only by way of the water separator 6. The basic operating mode N relates to an operating mode in which compressed air dried by the (first) air dryer 5, 5.1 is conveyed to the compressed air supply port 2. The second operating mode B2 relates to a distribution mode in which a part of the compressed air is used for regeneration of the first air dryer and the remaining part of the compressed air partially dehumidified by the water separator 6, or by a second air dryer 5.2, is conveyed to the compressed air supply port 2.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE SPECIFICATION)

1 Compressed air port
2 Compressed air supply port
3 Vent port
5 Air dryer
5.1 First air dryer
5.2 Second air dryer
6 Water separator
8 Throttle
8.1 First throttle
8.2 Second throttle
9 Pressure sensor
12 Pneumatic main line
13 Vent line
13.1 First vent line
13.2 Second vent line
13.3 Compressor vent line
14 Branch line
14.1 First branch line
14.2 Second branch line
15 Bypass line
16 Condensation dryer
20 Pneumatic assembly
21A Throttle point
21B Control pressure line
23 Vent valve assembly
23.1 First vent valve
23.2 Vent check valve
23.3 Second vent valve
23.4 Compressor vent valve
23.5 Control valve
23.6 Return flow protection valve
23.5AControl line
23.5BBypass
23.5CLine
24 Switch valve
24.1 First switch valve in branch line
24.2 Second switch valve in branch line
25 Pneumatic main line switch valve
26 Drainage element
27, 27.1, 27.2 First check valve
28, 28.1, 28.2 Second check valve
29, 29.1, 29.2 Recirculation throttle valve
36 Ventilation apparatus
40 Pressure regulator
50 Compressed air source
51 Reservoir
52 Reservoir switch valve
53 Reservoir pressure sensor
60 Temperature sensor array
100 Compressed air supply plant
70 Data interface
71 Vehicle data bus
72 CAN bus
100 Compressed air supply plant
101 Pressure control module
110 Compressed air at the compressed air port
120 Partially dehumidified compressed air in pneumatic main line
120′Dried compressed air in pneumatic main line
131 Humid compressed air in vent line
141 Compressed air in/from first branch line
141′ Relaxed compressed air from first branch line
200 Compressed air provider
201 Compressor
203 Electric motor
204 BLDC electric motor
300 Compressed air consumer
301 Sensor cleaning device
302 First nozzle valve
303 Second nozzle valves
304 2/2-way valve
305 Magnetic part
306 Pneumatic part
307 Coil
308 Armature
309 Air gap
310 First compressed air passage
311 Second compressed air passage
312 Valve plunger part
313 Contact surface
314 Valve spring
315 Valve seat
400 Air humidity sensor
410 Ambient temperature sensor
1000 Vehicle
1100 Passenger automobile
1200 Compressed air supply system
1300 Control apparatus
1310 Computing equipment
1320 Processor
1400 Front region of the vehicle
1600 On-board network
1610 On-board network accumulator
1620 On-board network battery
1700 Navigation system
2000, 4000, 5000 Method
2100 Receiving a supply demand
2110 Receiving a supply pressure and/or a supply volumetric flow
2120 Determining a permissible humidity content
2200 Actuating a compressed air provider
2210 Feedback-controlling the supply pressure and/or volumetric flow
2220 Actuating an additional compressed air source
2300 Identifying a regeneration implementation time of the (first) air dryer
2310 Calculating a saturation level
2320 Retrieving location and environmental information
2330 Location information (I_{GPS}) and environmental information
2400 Actuating a (first) branch line switch valve
2410 Actuating a vent valve
2420 Actuating a main line switch valve
2430 Actuating a pneumatic assembly
2431 Actuating a throttle valve
2432 Actuating a recirculation throttle valve
2500 Recirculating compressed air through the pneumatic main line
2600 Flushing the pneumatic main line and/or the branch line
2610 Flushing the compressed air consumer
2620 Actuating the compressor vent valve
2700 Pneumatic decoupling
4300 Identifying a regeneration implementation time of the second air dryer
4400 Selectively actuating a first branch line switch valve and/or main line switch valve
4500 Recirculating compressed air through the second branch line
5100 Energizing with a heating current
S1 First signal line to the temperature sensor array
S2 Second signal line to (first) branch line switch valve
S3 Third signal line to the (first) vent valve
S4 Fourth signal line to the pneumatic assembly
S5 Fifth signal line to the compressed air consumer
S6 Sixth signal line to the compressed air provider
S6.1 CAN bus connection
S7 Seventh signal line to the main line switch valve
S8 Eighth signal line to the on-board network
S9 Ninth signal line to the second branch line switch valve
S10 Tenth signal line to the compressor vent valve
S11 Eleventh signal line to the second vent valve
S12 Twelfth signal line to the vent valve control valve
F Direction of travel
B Filling direction
R Recirculating direction
E Venting direction
B1 First operating mode
B2 Second operating mode
N Basic operating mode
K Condensate
P Input pressure, sensor information
P_{V} Supply pressure
V_{V} Supply volumetric flow
B_{V} Supply demand
B_{R} Regeneration implementation time
B_{R1} First regeneration implementation time
B_{R2} Second regeneration implementation time
Hₘₐₓ Permissible humidity content
H Air humidity, sensor information
Hᵢₛ Current air humidity, sensor information
Hₚ Predicted air humidity, sensor information
T Temperature, sensor information
Tᵢₛₜ Current temperature, sensor information
Tₚ Predicted temperature, sensor information
S Sensor signal
Z Status variable
Zᵢₛₜ Current status variable
Zₚ Predicted status variable
G Saturation level
G1 First saturation level
G2 Second saturation level
M Motor speed
I_{GPS} Location information
P1 Initial position
P2 Target position
Pn Line routing
I_{U} Environmental information
T_{B} Operating time
T_{R} Period since the last regeneration
X Number of regenerations
I Current
V_{L} Line volume
F_{F} Spring force
F_{M} Magnetic force
S_{I} Control current
S_{I1} Opening control current
S_{I2} Holding control current
S_{I3} Heating control current
P_{S} Control pressure
Q Flow cross section
W Range of values

1. A method for controlling a compressed air supply system for a vehicle, wherein the compressed air supply system, for supplying a compressed air consumer via a compressed air supply port, is assigned a control device, and the compressed air supply system has a compressed air provider for providing compressed air at a compressed air port, a pneumatic main line with a water separator for separating humidity from the compressed air, an air dryer disposed downstream of the water separator in a filling direction for drying and directing compressed air to the compressed air supply port in the filling direction, and a branch line emanating from the pneumatic main line in the filling direction upstream of the air dryer and reconnecting downstream of the air dryer, the method comprising:
receiving a supply demand of the compressed air consumer by the control device;
identifying a regeneration implementation time of the air dryer by the control device as a function of at least one of the supply demand and a saturation level of the air dryer defined by at least one status variable;
actuating the compressed air provider by the control device for providing the compressed air at the compressed air port, should the control device receive the supply demand of the compressed air consumer;
actuating a branch line switch valve by the control device for fluidically opening the branch line pneumatically in a first operating mode, in an event that the control device identifies the regeneration implementation time; and,
recirculating the compressed air from the branch line counter to the filling direction through the pneumatic main line for regenerating the air dryer in the first operating mode.

2. The control method of claim 1, wherein said receiving the supply demand furthermore includes at least one of:
receiving a supply pressure and/or a supply volumetric flow of the compressed air to be provided at the compressed air supply port by the control device; and,
determining a permissible humidity content of the compressed air to be provided at the compressed air supply port by the control device.

3. The control method of claim 2, wherein the control device determines a permissible humidity content as a function of at least one of:
a temperature and/or air humidity of an environment; and,
an operating time of the compressed air provider which is monitored by the control device via a signal connection.

4. The control method of claim 3, wherein at least one of:
the temperature of the environment is detected by an ambient temperature sensor; and,
the air humidity of the environment is detected by a humidity sensor.

5. The control method of claim 2, wherein:
the control device is connected to a pneumatic assembly assigned to the compressed air supply port;
said actuating the compressed air provider by the control device furthermore includes at least one of:
feedback-controlling at least one of the supply pressure and the supply volumetric flow of the compressed air provided at the compressed air supply port by the control device as a function of the supply demand and furthermore of a pressure in the pneumatic main line and/or of a motor speed of an electric motor connected for signals to the control device, detected by a pressure sensor,
wherein the control device is connected to the electric motor and said feedback-controlling the supply pressure includes feedback-controlling the motor speed of the electric motor by the control device via at least one of:
controlling the pneumatic assembly by the control device as a function of sensor signals of a temperature sensor array assigned to the compressed air provider and/or the supply demand and/or the saturation level of the air dryer; and,
actuating an additional compressed air source as a function of the supply demand and/or the saturation level of the air dryer and/or of the sensor signal of the temperature sensor array assigned to the compressed air provider.

6. The control method of claim 2, wherein the control device identifies the regeneration implementation time, should at least one of the supply pressure, the supply volumetric flow, the permissible humidity content, and the at least one status variable be outside a predefined value range.

7. The control method of claim 1, wherein the at least one status variable includes at least one of: an operating time of the compressed air provider and/or a motor speed of an electric motor, a number of regenerations and time period since a last regeneration of the air dryer, the method further comprising:
calculating the saturation level as a function of a temperature of an environment and an air humidity of the environment and at least one of: operating time of the compressed air provider and/or motor speed of the electric motor, the number of regenerations, the time period since the last regeneration of the air dryer, number of actuations and/or an actuation time of at least one of the branch line switch valve and a main-line switch valve disposed in the pneumatic main line.

8. The control method of claim 7, wherein at least one of the temperature and the air humidity include a current temperature and/or air humidity of the environment, the method further comprising:
accessing at least one of the current temperature and the air humidity by the control device from a connected, signal conducting ambient temperature sensor and/or air humidity sensor or from a connected, signal conducting on-board network.

9. The control method of claim 7, wherein at least one of the temperature and the air humidity of the environment includes at least one of a predicted temperature and the air humidity of the environment along a route and/or at a destination, and identifying the regeneration implementation time of the air dryer includes accessing location information and environmental information as a function of the location information by the control device from at least one of a connected, signal conducting on-board network and a navigation system.

10. The control method of claim 1 further comprising at least one of:
actuating a vent valve by the control device for releasing a vent line emanating in the filling direction upstream of the air dryer from the pneumatic main line to a vent port, should the control device identify the regeneration implementation time; and,
actuating a compressor vent valve for venting a line volume between the compressed air provider and the compressed air consumer.

11. The control method of claim 10, further comprising actuating a main line switch valve for blocking the pneumatic main line in the filling direction should the control device identify the regeneration implementation time.

12. The control method of claim 9, further comprising actuating a main line switch valve for blocking the pneumatic main line in the filling direction upstream of the air dryer, should the control device identify the regeneration implementation time.

13. The control method of claim 1, further comprising at least one of:
flushing at least one of: the pneumatic main line counter to the filling direction and the branch line in the filling direction by the compressed air provided at the compressed air port and dried by the air dryer, and discharging the compressed air via the vent line;
flushing the compressed air consumer by the compressed air provided at the compressed air port and dried by the air dryer, and discharging the compressed air via the compressed air consumer;
actuating a main line switch valve, the branch line switch valve for pneumatically decoupling the pneumatic main line and the branch line from the compressed air port;
actuating the main line switch valve, the branch line switch valve for pneumatically decoupling the air dryer and the branch line from the compressed air port; and,
actuating the main line switch valve, the branch line switch valve and actuating a vent valve for pneumatically decoupling the compressed air supply system from the compressed air provider and an environment.

14. The control method of claim 1, wherein the compressed air supply system has a pneumatic assembly assigned to the compressed air supply port and connected for signals to the control device, the method further comprising at least one of:
pre-filling the pneumatic main line with the compressed air via the compressed air port, wherein the pneumatic assembly pneumatically decouples at least one of the pneumatic main line and the compressed air supply port from the compressed air consumer; and,
actuating the pneumatic assembly for releasing at least one of the compressed air supply port and the pneumatic main line after pre-filling the pneumatic main line.

15. The control method of claim 1, wherein the compressed air supply system has a pneumatic assembly assigned to the compressed air supply port and connected for signals to the control device, the method further comprising:
actuating the pneumatic assembly by the control device for distributing, as a function of the supply demand and of the identified regeneration implementation time, the compressed air carried in the branch line to at least one of the pneumatic main line for recirculation counter to the filling direction and to the compressed air supply port.

16. The control method of claim 15, further comprising at least one of:
actuating a throttle valve of the pneumatic assembly for feedback-controlling a supply pressure at the compressed air supply port; and,
actuating a recirculation throttle valve to feedback-control a pressure of the compressed air recirculated in an opposite filling direction.

17. The control method of claim 1, wherein the regeneration implementation time is a first regeneration implementation time, the air dryer is a first air dryer, the saturation level is a first saturation level, and the branch line is a first branch line; and, the compressed air supply system further has a second branch line with a second branch line switch valve and a second air dryer, the method further comprising:
selectively actuating, as a function of a second saturation level of the second air dryer, at least one of the first branch line switch valve and the second branch line switch valve, should the control device identify the first regeneration implementation time of the first air dryer.

18. The control method of claim 17, further comprising:
identifying a second regeneration implementation time of the second air dryer by the control device as a function of at least one of the supply demand and the second saturation level of the second air dryer;
selectively actuating at least one of the first branch line switch valve and the main-line switch valve by the control device for fluidically opening at least one of the first branch line and the pneumatic main line pneumatically, should the control device identify the second regeneration implementation time of the second air dryer; and,
recirculating the compressed air from at least one of the first branch line and the pneumatic main line counter to the filling direction through the second branch line for regenerating the second air dryer.

19. The control method of claim 1, wherein the vehicle is a passenger automobile.

20. The control method of claim 1, wherein said actuating the compressed air provider is achieved by actuating an electric motor assigned to the compressed air provider.

21. A control device for controlling a compressed air supply system for a vehicle, wherein the control device is assigned to the compressed air supply system for supplying a compressed air consumer via a compressed air supply port, and the compressed air supply system has a compressed air provider for providing compressed air at a compressed air port, a pneumatic main line with an air dryer for drying and directing the compressed air to the compressed air supply port in a filling direction, and a branch line emanating from the pneumatic main line in the filling direction upstream of the air dryer and reconnecting downstream of the air dryer, the control device comprising:
a controller having an input configured to receive a supply demand of the compressed air consumer;
said controller being configured to actuate the compressed air provider and being connected for signals to the compressed air consumer and the compressed air provider; and,
said controller being configured to identify a regeneration implementation time as a function of at least one of the supply demand and a saturation level of the air dryer; and,
said controller being further configured to control a branch line switch valve to fluidically open a branch line pneumatically when the regeneration implementation time is identified.

22. The control device of claim 21, wherein at least one of:
the vehicle is a passenger automobile;
the regeneration implementation time is a first regeneration implementation time, the air dryer is a first air dryer, the saturation level is a first saturation level, and the branch line is a first branch line; the compressed air supply system further has a second branch line with a second switch valve and a second air dryer; said controller is configured to identify at least one of the first regeneration implementation time as a function of at least one of the supply demand and the first saturation level of the first air dryer and a second regeneration implementation time as a function of at least one of the supply demand and a second saturation level of the second air dryer; and,
the compressed air provider is a compressor.

23. A vehicle comprising:
a compressed air supply system for supplying a compressed air consumer via a compressed air supply port;
said compressed air supply system having a compressed air provider for providing compressed air to a compressed air port, a pneumatic main line with an air dryer for drying and conducting compressed air to said compressed air supply port in a filling direction, and a branch line emanating from said pneumatic main line in the filling direction upstream of said air dryer and reconnecting downstream of said air dryer;
a control device assigned to said compressed air supply system;
said control device being configured to receive a supply demand of said compressed air consumer and to actuate said compressed air provider and to be connected for signals to said compressed air consumer and said compressed air provider; and,
said control device being further configured to identify a regeneration implementation time as a function of at least one of the supply demand and a saturation level of said air dryer and to control a branch line switch valve to fluidically open said branch line pneumatically when the regeneration implementation time is identified.

24. The vehicle of claim 23, further comprising at least one of:
at least one sensor connected to said control device and configured to provide sensor information for determining the saturation level of the air dryer and a permissible humidity; and,
at least one data interface connected for signals to said control device and configured to provide stored sensor information for determining at least one of the saturation level of the air dryer and a permissible humidity.

25. The vehicle of claim 23 further comprising:
an on-board network connected via a data interface to said control device and configured to provide at least one of: location information of a navigation system, environmental information assigned to the location information, stored sensor information of an on-board network memory, sensor information of at least one sensor connected to said on-board network; and,
an on-board network battery configured to supply current to at least one of said on-board network, said compressed air provider, said compressed air consumer, and said control device.

26. The vehicle of claim 23, wherein at least one of:
the vehicle is a passenger automobile; and,
the compressed air provider is a compressor.

27. The vehicle of claim 24, wherein said at least one data interface is at least one of a vehicle data bus and a CAN bus.

28. The vehicle of claim 25, wherein at least one of:
said at least one sensor includes at least one of a temperature sensor and an air humidity sensor; and,
said control device is configured to determine a parameter including at least one of a current temperature of the environment, a predicted temperature of the environment, a current air humidity of the environment, and a predicted air humidity of the environment as a function of at least one of: the sensor information, the location information, the environmental information, wherein the parameter is at least at one of: a current location, along a route, and at a destination.
